(19) United States
(12) Patent Application Publication
(10) Pub. No.: US 2016/0184795 A1
(43) Pub. Date: Jun. 30, 2016

(54) METHODS AND SYSTEMS FOR PROCESSING CELLULOSIC BIOMASS

(71) Applicant: SHELL OIL COMPANY, Houston, TX (US)

(72) Inventors: Joseph Broun POWELL, Houston, TX (US); Glenn Charles KOMPLIN, Katy, TX (US); Juben Nemchand CHHEDA, Houston, TX (US)

(21) Appl. No.: 14/980,375

(22) Filed: Dec. 28, 2015

Related U.S. Application Data
(60) Provisional application No. 62/097,669, filed on Dec. 30, 2014.

(51) Int. Cl. B01J 19/24; B01D 3/14

(52) U.S. Cl. CPC B01J 19/24; B01D 3/148; B01J 2219/24

(57) ABSTRACT

Separation of a product of digestion of cellulosic biomass solids may be challenging due to the various components contained therein. Methods and systems for processing cellulosic biomass, particularly a reaction product of a hydrothermal reaction containing lignin-derived products, such as phenolics, comprise providing the reaction product to a separation zone comprising a liquid-liquid phase separation unit. The liquid-liquid phase separation unit can provide an aqueous portion and a non-aqueous portion, where these portions can be separated into various fractions individually. For example, desirable compounds in the aqueous portion and non-aqueous portion can be recovered from the portions individually and optionally combined to be further processed into a fuels product. Heavier components in the aqueous portion and non-aqueous portion can be recovered from the portions individually and used in the process, such as phenolics that can be used as a digestion solvent.

### CROSS-REFERENCE TO RELATED APPLICATION

This non-provisional application claims the benefit of 62/097,669, filed Dec. 30, 2014, the disclosures of which are incorporated herein by reference.

### TECHNICAL FIELD OF THE INVENTION

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of any prior art.

### BACKGROUND TO THE INVENTION

The present disclosure generally relates to processing of cellulosic biomass solids, and, more specifically, to methods and systems for processing a reaction product comprising lignin that may be obtained by a hydrothermal reaction of cellulosic biomass.

A number of substances of commercial significance may be produced from natural sources, including biomass. Cellulosic biomass may be particularly advantageous in this regard due to the versatility of the abundant carbohydrates found therein in various forms. As used herein, the term “cellulosic biomass” refers to a living or formerly living biological material that contains cellulose. The lignocellulosic material found in the cell walls of higher plants is the world's largest source of carbohydrates. Materials commonly produced from cellulosic biomass may include, for example, paper and pulpwood via partial digestion, biofuels, including bioethanol by fermentation.

Development of fossil fuel alternatives derived from renewable resources have received recent attention. Cellulosic biomass has garnered particular attention in this regard due to its abundance and the versatility of the various constituents found therein, particularly cellulose and other carbohydrates. Despite promise and intense interest, the development and implementation of bio-based fuel technology has been slow. Existing technologies have heretofore produced fuels having a low energy density (e.g., bioethanol) and/or that are not fully compatible with existing engine designs and transportation infrastructure (e.g., methanol, biodiesel, Fischer-Tropsch diesel, hydrogen, and methane). Moreover, conventional bio-based processes have typically produced intermediates in dilute aqueous solutions (>50% water by weight) that are difficult to further process. Energy- and cost-efficient processes for processing cellulosic biomass into fuel blends having similar compositions to fossil fuels would be highly desirable to address the foregoing issues and others.

Further, in addition to the desired carbohydrates, other substances may be present within cellulosic biomass that can be especially problematic to deal with in an energy- and cost-efficient manner. For example, during cellulosic biomass processing, significant quantities of lignin present in cellulosic biomass may lead to fouling of processing equipment, potentially leading to costly system down time. The lignin can also lead to realization of a relatively low conversion of the cellulosic biomass into useable substances per unit weight of feedstock.

As evidenced by the foregoing, an efficient conversion of cellulosic biomass into fuel blends and other materials is a complex problem that presents immense engineering challenges. The present disclosure addresses these challenges and provides related advantages as well.

### SUMMARY OF THE INVENTION

Recovery of various compounds from a product of reactions involving cellulosic biomass may be challenging due to the various components contained therein, including lignin. The present disclosure provides methods and systems for processing cellulosic biomass, particularly separation of a reaction product of a hydrothermal reaction containing lignin and lignin-derived products, where the reaction product is a mixture of various compounds and typically in more than one liquid phase. One phase of the reaction product is usually water. While feasible, distillation of a reaction product with multiple liquid phases that contains water into various product fractions can result in poor product separation and steam stripping, where water vapors carry heavier compounds, like phenols, into the overhead fraction. Although this may be addressed by conducting the distillation at higher pressure and temperature where multiple phases can be reduced or minimized, the higher pressure and temperature presents additional expenses including equipment costs, as well as risks to product from onset of undesired degradation reactions at higher temperatures. While the water in the reaction product can be removed through flashing prior to full distillation into product fractions, doing so can also result in steam stripping, thereby resulting in less efficient product separation in a subsequent distillation process.

The methods and systems provided in the present disclosure address the foregoing issues by providing liquid-liquid phase separation to isolate the phases so that the phases can be further processed independent of each other. Once separated, the aqueous phase can be subject to flashing with reduced carryover of the less volatile organic components, including phenols and various oils, into the overhead distillate because a majority of the excess amount of these components which is not soluble in water has been removed. The remaining low concentration of organic components that is soluble in water is subject to a dilution effect that minimizes vaporization. Flashing of the aqueous phase can recover various light compounds that can be further processed into a fuel product. Light compounds can include those with a normal boiling point of less than about 150 degrees C., including but not limited to monohydric alcohols (e.g., mono-oxygenates), aldehydes, ketones, acids, and any combination thereof.

Flashing or distillation of a single phase of the non-aqueous phase(s) with reduced water concentration can achieve adequate product separation at a lower temperature whereas higher temperatures would be needed to obtain a single liquid phase at higher concentrations of water, to achieve similar efficient product separations in distillation The product fractions from distillation of the non-aqueous phase(s) can include at least an overhead fraction comprising light compounds, a middle fraction comprising lignin and lignin-derived products, including phenols, and a bottom fraction comprising heavy compounds with normal boiling points above about 350° C. The distillation can be performed to provide more than one middle fraction. For instance, distillation can be operated to provide a first middle fraction with a normal boiling point of about 150 to 250 degrees C. and a second middle fraction with a higher normal boiling point of 200 to 350 degrees C. Distillation can also be operated to provide a middle fraction with a normal boiling point of about 150 to 350 degrees C.

The light compounds recovered from the aqueous phase and the non-aqueous phase(s) can optionally be combined for further processing into a fuels product. A middle fraction recovered from the non-aqueous phase(s) can be recycled in the process in various manners, including for use as solvent or for further conversion to other intended products. For instance, a middle fraction can be provided to one or more hydrothermal reaction steps that generate the reaction product. In particular, a middle fraction comprising phenols can be used as a digestion solvent in a hydrothermal reaction. Optionally, to improve product separation, the non-aqueous phase(s) can be subject to a viscosity reducing reaction prior to full distillation, including one or more lignin depolymerization reactions.

In particular, the current disclosure provides a method comprising: heating cellulosic biomass solids, molecular hydrogen, a catalyst capable of activating molecular hydrogen, and a digestion solvent in a reactor in a first reaction zone to produce a first reaction product; providing at least a portion of the first reaction product to a separation zone comprising a liquid-liquid phase separation unit to recover an aqueous stream and a non-aqueous stream, wherein the aqueous stream comprises a major portion of water in said portion of the first reaction product; and providing at least a portion of the non-aqueous stream to a distillation unit to recover an overhead fraction, a middle fraction, and a bottom fraction; and providing at least a portion of the middle fraction to the reactor in the first reaction zone.

In addition, the current disclosure provides another method comprising: heating cellulosic biomass solids, molecular hydrogen, a catalyst capable of activating molecular hydrogen, and a digestion solvent in a reactor in a first reaction zone to produce a first reaction product; heating at least a portion of the first reaction product, molecular hydrogen, and a catalyst capable of activating molecular hydrogen, in a reactor in a second reaction zone to produce a second reaction product; providing at least a portion of the second reaction product to a separation zone comprising a liquid-liquid phase separation unit to recover an aqueous stream and a non-aqueous stream, wherein the aqueous stream comprises a major portion of water in said portion of the second reaction product; providing at least a portion of the non-aqueous stream to a distillation unit to recover an overhead fraction, a middle fraction, and a bottom fraction; and providing at least a portion of the middle fraction to at least one of the reactor in the first reaction zone and the reactor in the second reaction zone.

In addition, the current disclosure provides a system comprising: a first reaction zone comprising a reactor configured heat cellulosic biomass solids, molecular hydrogen, a catalyst capable of activating molecular hydrogen, and a digestion solvent to form a first reaction product; and a separation zone comprising: a liquid-liquid phase separation unit having an inlet in fluid communication with an outlet of the reactor in the first reaction zone to receive the first reaction product, wherein the liquid-liquid phase separation unit is configured to provide an aqueous stream and a non-aqueous stream, wherein the aqueous phase comprises a major portion of water in said portion of the first reaction product; and a distillation unit having an inlet in fluid communication with an outlet of the liquid-liquid phase separation unit to receive at least a portion of the non-aqueous stream, wherein the distillation unit is configured to provide at least an overhead fraction, a middle fraction, and a bottom fraction; wherein the distillation unit is in fluid communication with an inlet of the reactor in the first reaction zone to provide at least a portion of the middle fraction.

In addition, the current disclosures provides another system comprising: a first reaction zone comprising a reactor configured heat cellulosic biomass solids, molecular hydrogen, a catalyst capable of activating molecular hydrogen, and a digestion solvent to form a first reaction product; a second reaction zone comprising a reactor in fluid communication with an outlet of the reactor in the first reaction zone to receive the first reaction product, wherein the reactor in the second reaction zone is configured to heat a second reaction content comprising the first reaction product, molecular hydrogen, and a catalyst capable of activating molecular hydrogen to form a second reaction product; and a separation zone comprising: and a liquid-liquid phase separation unit having an inlet in fluid communication with an outlet of the reactor in the second reaction zone to receive the second reaction product, wherein the liquid-liquid phase separation unit is configured to provide an aqueous stream and a non-aqueous stream, wherein the aqueous stream comprises a major portion of water in said portion of the first reaction product; and a distillation unit having an inlet in fluid communication with an outlet of the liquid-liquid phase separation unit to receive at least a portion of the non-aqueous stream, wherein the distillation unit is configured to provide at least an overhead fraction, a middle fraction, and a bottom fraction; wherein the distillation unit is in fluid communication with an inlet of the reactor in the first reaction zone to provide at least a portion of the middle fraction; and wherein the distillation unit is in fluid communication with an inlet of the reactor in the second reaction zone to provide at least a portion of the middle fraction.

The features and advantages of embodiments provided by the present disclosure will be readily apparent to one having ordinary skill in the art upon a reading of the description of the embodiments that follows.

### BRIEF DESCRIPTION OF THE DRAWINGS

The following figures are included to illustrate certain aspects of the present disclosure, and should not be viewed as an exclusive embodiment. The subject matter disclosed is capable of considerable modifications, alterations, combinations, and equivalents in form and function, as will occur to one having ordinary skill in the art and the benefit of this disclosure.

FIG. 1 shows a schematic of a first illustrative embodiment for processing cellulosic biomass according to some aspects provided by this disclosure.

FIG. 2 shows a schematic of a second illustrative embodiment for processing cellulosic biomass according to some aspects provided by this disclosure.

FIG. 3 shows an illustrative embodiment of a separation zone involved in processing of cellulosic biomass according to some aspects provided by this disclosure.

FIG. 4 shows an illustrative embodiment of an aqueous stream separation zone involved in processing of cellulosic biomass according to some aspects provided by this disclosure.

### DETAILED DESCRIPTION

The present disclosure generally provides methods for processing cellulosic biomass into a fuel product, particularly processing of a reaction product obtained from hydrothermal digestion of cellulosic biomass solids. Cellulosic biomass is particularly advantageous because of the versatility of the abundant carbohydrates found therein in various forms. As used herein, the term “cellulosic biomass” refers to a living or formerly living biological material that contains cellulose. The lignocellulosic material found in the cell walls of higher plants is one of the world's largest sources of carbohydrates.

Unless otherwise specified, it is to be understood that use of the terms “biomass” or “cellulosic biomass” may be synonymous. The cellulosic biomass may be in any size, shape, or form. The cellulosic biomass may be natively present in any of these solid sizes, shapes, or forms, or they may be further processed prior to digestion. The cellulosic biomass may be chopped, ground, shredded, pulverized, and the like to produce a desired size prior to hydrothermal digestion. The cellulosic biomass may be washed (e.g., with water, an acid, a base, combinations thereof, and the like) prior to digestion taking place.

Any type of suitable cellulosic biomass source may be used. Suitable cellulosic biomass sources may include, for example, forestry residues, agricultural residues, herbaceous material, municipal solid wastes, waste and recycled paper, pulp and paper mill residues, and any combination thereof. Thus, in some embodiments, a suitable cellulosic biomass may include, for example, corn stover, straw, bagasse, miscanthus, sorghum residue, switch grass, bamboo, water hyacinth, hardwood, hardwood chips, hardwood pulp, softwood, softwood chips, softwood pulp, duckweed and any combination thereof. Leaves, roots, seeds, stalks, husks, and the like may be used as a source of the cellulosic biomass. Common sources of cellulosic biomass may include, for example, agricultural wastes (e.g., corn stalks, straw, seed hulls, sugarcane leavings, nut shells, and the like), wood materials (e.g., wood or bark, sawdust, timber slash, mill scrap, and the like), municipal waste (e.g., waste paper, yard clippings or debris, and the like), and energy crops (e.g., poplars, willows, switch grass, alfalfa, prairie bluestream, corn, soybeans, and the like). The cellulosic biomass may be chosen based upon considerations such as, for example, cellulose and/or hemicellulose content, lignin content, growing time/season, growing location/transportation cost, growing costs, harvesting costs, and the like.

Plants have primary cell walls and secondary cell walls. The primary cell wall contains three major polysaccharides (cellulose, pectin, and hemicellulose) and one group of glycoproteins. The secondary cell wall also contains polysaccharides polymeric lignin that is covalently crosslinked to hemicellulose. The complex mixture of constituents that is co-present with the cellulose can make its processing difficult, as discussed hereinafter. Lignin, in particular, may be an especially difficult constituent to deal with.

When converting cellulosic biomass into fuel blends and other materials, cellulose and other complex carbohydrates therein can be extracted and transformed into simpler organic molecules, which can be further processed thereafter. Digestion is one way in which cellulose and other complex carbohydrates may be converted into a more usable form. Digestion processes can break down cellulose and other complex carbohydrates within cellulosic biomass into simpler, soluble carbohydrates that are suitable for further transformation through downstream further processing reactions. As used herein, the term “soluble carbohydrates” refers to monosaccharides or polysaccharides that become solubilized in a digestion process. Illustrative carbohydrates that may be present in cellulosic biomass solids include, for example, sugars, sugar alcohols, celluloses, lignocelluloses, hemicelluloses, and any combination thereof.

The issues associated with converting cellulosic biomass into fuel blends (biofuels) in an energy- and cost-efficient manner using digestion are not only complex, but they are entirely different than those that are encountered in the digestion processes commonly used in the paper and pulpwood industry. Since the intent of cellulosic biomass digestion in the paper and pulpwood industry is to retain a solid material (e.g., wood pulp), incomplete digestion is usually performed at low temperatures (e.g., less than about 200° C.) for a fairly short period of time (e.g., between two to four hours). In contrast, digestion processes suitable for converting cellulosic biomass into fuel blends and other materials are ideally configured to maximize yields by solubilizing as much of the original cellulosic biomass charge as possible in a high-throughput manner. Paper and pulpwood digestion processes also typically remove lignin from the raw cellulosic biomass prior to pulp formation. Although digestion processes used in connection with forming fuel blends and other materials may likewise remove lignin prior to digestion, these extra process steps may impact the energy efficiency and cost of the biomass conversion process. The presence of lignin during high-conversion cellulosic biomass digestion may be particularly problematic.

Production of soluble carbohydrates for use in fuel blends and other materials via routine modification of paper and pulpwood digestion processes is not believed to be economically feasible for a number of reasons. Simply running the digestion processes of the paper and pulpwood industry for a longer period of time to produce more soluble carbohydrates is undesirable from a throughput standpoint. Use of digestion promoters such as strong alkalis, strong acids, or sulfites to accelerate the digestion rate can increase process costs and complexity due to post-processing separation steps and the possible need to protect downstream components from these agents. Accelerating the digestion rate by increasing the digestion temperature can actually reduce yields of biofuels due to thermal degradation of soluble carbohydrates that can occur at elevated digestion temperatures, particularly over extended periods of time. Once produced by digestion, soluble carbohydrates are very reactive and can rapidly degrade to produce caramelans and other heavy ends degradation products or byproducts, especially under higher temperature conditions, such as above about 150 degrees C. Use of higher digestion temperatures can also be undesirable from an energy efficiency standpoint. Any of these difficulties can defeat the economic viability of fuel blends derived from cellulosic biomass.

A particularly effective manner in which soluble carbohydrates may be formed is through hydrothermal digestion, and in which the soluble carbohydrates may be converted into more stable compounds is through subjecting them to one or more catalytic reductions, which may include hydrogenation and/or hydrogenolysis reactions. Stabilizing soluble carbohydrates through conducting one or more catalytic reduction reactions may allow digestion of cellulosic biomass to take place at higher temperatures than would otherwise be possible without unduly sacrificing yields. Depending on the reaction conditions and catalyst used, reaction products formed because of conducting one or more catalytic reduction reactions on soluble carbohydrates may comprise one or more alcohol functional groups, particularly including triols, glycol, monohydric alcohols, and any combination thereof, some of which may also include a residual carbonyl functionality (e.g., an aldehyde or a ketone). The compounds in the alcoholic component can be described as oxygenates where the compounds comprise one or more oxygen-containing functional groups, such as a hydroxyl group or a carbonyl group. Non-limiting examples of oxygenates include an aldehyde, a ketone, an alcohol, furan, an ether, or any combination thereof. Such reaction products are more thermally stable than soluble carbohydrates and may be readily transformable into fuel blends and other materials through conducting one or more downstream further processing reactions. In addition, the foregoing types of reaction products are good solvents in which a hydrothermal digestion may be performed, thereby promoting solubilization of soluble carbohydrates as their reaction products.

Hydrothermal digestion of a cellulosic biomass can include heating of the cellulosic biomass and a digestion solvent in the presence of molecular hydrogen and a catalyst capable of activating the molecular hydrogen (which can also be referred to herein as a “hydrogen-activating catalyst” or “hydrocatalytic catalyst”). In such approaches, the hydrothermal digestion of cellulosic biomass and the catalytic reduction of soluble carbohydrates produced therefrom may take place in the same vessel, which can be referred to as “in situ catalytic reduction reaction processes.” As such, digestion processes suitable for converting cellulosic biomass into fuel blends and other materials are preferably configured to maximize yields by solubilizing as much of the original cellulosic biomass charge as possible in a high-throughput manner. In situ catalytic reduction reaction processes may also be particularly advantageous from an energy efficiency standpoint, since hydrothermal digestion of cellulosic biomass is an endothermic process, whereas catalytic reduction reactions are exothermic. Thus, the excess heat generated by the in situ catalytic reduction reaction(s) may be utilized to drive the hydrothermal digestion with little opportunity for heat transfer loss to occur, thereby lowering the amount of additional heat energy input needed to conduct the digestion.

Typically, hydrothermal reactions of cellulosic biomass, including hydrothermal digestion and catalytic reduction, generates a reaction product that contains a variety of components, ranging from lighter compounds, such as an alcoholic component, to heavier compounds, including lignin and lignin-derived compounds, such as phenolics, and various compounds in between. The reaction product can also exist in more than one phase, depending on certain conditions, such as temperature and pressure. Because the reaction product is a mixture of compounds, further processing certain compounds to desired products can be challenging. For instance, further processing of certain light compounds in the reaction product to desired fuel products can be challenging, at least from an economics point of view, because other middle-boiling compounds, such as lignin and lignin-derived compounds also present, can limit further processing options of the components in the reaction product.

For example, the lignin present in the reaction product may lead to fouling of processing equipment, potentially leading to costly system down time. The reaction product is a mixture of various compounds and typically in more than one liquid phase. One phase of the reaction product is usually water. While feasible, distillation of a reaction product containing water into various product fractions typically requires higher temperatures and pressures compared to one with reduced water. The extra energy needed for the higher temperatures and pressures can translate into additional costs. While the water in the reaction product can be removed through flashing prior to distillation into product fractions, doing so can result in steam stripping where water vapors carry some phenols into the overhead fraction. Removal of phenols during flashing can result in less efficient product separation in a subsequent distillation process.

The methods and systems provided in the present disclosure address the foregoing issues by providing liquid-liquid phase separation to isolate the phases so that the phases can be further processed independent of each other. The reaction product can comprise an aqueous phase and one or more non-aqueous phases, which can be mixed with one another in an emulsion. Two streams that result from the liquid-liquid phase separation process include a non-aqueous stream that contains a major portion of the non-aqueous phase(s) and an aqueous stream that contains a major portion of the aqueous phase. Accordingly, the aqueous stream comprises a major portion of water present in the reaction product, while the non-aqueous stream comprises a minor portion of water present in the reaction product. The term “major” or grammatical equivalents thereof refers to greater than 50 wt %, including 55 wt % or greater, 60 wt % or greater, 70 wt % or greater, 75 wt % or greater, 80 wt % or greater, 85 wt % or greater, 90 wt % or greater, and 95 wt % or greater. The term “minor” or grammatical equivalents thereof means up to 50 wt %, including an amount in a range of 0.1 wt % and up to 50 wt %, up to 45 wt %, up to 40 wt %, up to 35 wt %, up to 30 wt %, up to 25 wt %, up to 20 wt %, up to 15 wt %, up to 10 wt %, or up to 5 wt %.

Once separated, the aqueous stream can be subject to flashing with reduced steam stripping effect because it contains a reduced amount of non-water miscible compounds compared to the reaction product with multiple liquid phases because a major portion of the non-water miscible compounds, such as phenols, are in the non-aqueous stream. Flashing of the aqueous stream recovers various light compounds that can be further processed into a fuel product. As mentioned, light compounds can include those with a normal boiling point of less than about 150 degrees C., including but not limited to monohydric alcohols, aldehydes, ketones, acids, and any combination thereof. The terms “light,” “middle-boiling,” and “heavy,” or grammatical variations thereof, refer to various compounds relative to one another based on their normal boiling points.

The non-aqueous stream with reduced water can be subject to full distillation to obtain various product fractions with a similar degree of product separation at lower temperatures and pressures compared to distillation of the reaction product containing more water or one that has been subject to flashing prior to distillation. The product fractions from the non-aqueous stream can include at least an overhead fraction comprising light compounds, a middle fraction comprising lignin and lignin-derived products, including phenols, and a bottom fraction comprising waste. The non-aqueous stream can also comprise an amount of longer diols and mono-oxygenates (such as those with greater than C4) formed from carbohydrates, which can be recovered in the middle fraction. The distillation can be performed to provide more than one middle fractions. For instance, distillation can be operated to provide a first middle fraction with a normal boiling point of about 150 to 250 degrees C. and a second middle fraction with a higher normal boiling point of 200 to 350 degrees C. Distillation can also be operated to provide a middle fraction with a normal boiling point of about 150 to 350 degrees C.

As known to one of ordinary skill in the art, the overlap in the range of normal boiling point of the middle fractions is at least due to the distribution of compounds during the distillation process. For instance, trace amounts of light compounds may be found in a middle fraction and/or a bottom fraction, and vice versa, trace amounts of heavy compounds may be found in the overhead fraction and/or middle fraction. Likewise, there would be an overlap of compounds in the more than one middle fractions, if present, which leads to an overlap of normal boiling point of the middle fractions. In general, the first middle fraction may be referred to as the phenols fraction because it tends to capture compounds with normal boiling points around that of phenolic compounds. It is understood that the first middle fraction can contain other compounds from the second middle fraction as well as those with normal boiling points falling outside of about 150 to 250 degrees C. as discussed above. Similarly, the second middle fraction may be referred to as the lignin oligomers fraction because it tends to capture heavier compounds with normal boiling points around that of lignin oligomers. It is understood that the second middle fraction can contain other compounds from the first middle fraction as well as those with normal boiling points falling outside of about 200 to 350 degrees C. as discussed above. The middle fraction, whether or not it is in one fraction or more than one fractions, contains a major portion of the phenols in the reaction product fed to the distillation process.

The light compounds recovered from the aqueous stream and the non-aqueous stream can optionally be combined for further processing into a fuels product. A middle fraction recovered from the non-aqueous stream can be recycled in the process. For instance, a middle fraction can be provided to one or more hydrothermal reaction steps that generate the reaction product. In particular, a middle fraction can be used as a digestion solvent in a hydrothermal reaction. The middle fraction can comprise cyclic alcohols and phenols, particularly at least one of cyclohexanols, alkyl cyclohexanols, cyclopentanols, and alkyl cyclopentanols, and alkyl phenols, respectively. At least a portion of the cyclohexanols and cyclopentanols can be derived from sugars, at least a portion of the alkyl cyclohexanols and alkyl cyclpentanols can be derived from lignin, and at least a portion of the alkyl phenols is derived from lignin. The middle fraction may further comprise lignin oligomers.

Optionally, to improve product separation of the non-aqueous stream in distillation, at least one of the reaction product and the non-aqueous stream can be subject to a viscosity reducing reaction prior to full distillation, including one or more lignin depolymerization reactions. Accordingly, the methods and systems described in the present disclosure can provide for improved yields and lower costs, including reducing or minimizing the need to employ expensive high pressure distillation and separations to process the reaction product.

The term “distillation” has its ordinary meaning, which refers to a method of recovering volatile compounds based on their normal boiling points. Distillation can be done in one stage or multiple stages. A one-stage of single stage distillation may be referred to as “flashing” or a grammatical equivalent, including “flash” or “flasher.” Flashing produces an overhead fraction and a bottom fraction and typically does not produce a middle product fraction. Multi-stage distillation produces various product fractions, including an overhead fraction and a bottom fraction, as well as one or more middle fractions. The manner in which flashing or multi-stage distillation can be carried out is known to one of ordinary skill in the art.

Unless otherwise specified, it is understood that the mention of various components, such as compounds, products, phases fractions, portions, streams, etc., in this disclosure refers to “at least a portion of” such component, whether or not the phrase “at least a portion of” is included therewith. The terms “hydrocarbon compounds,” “hydrocarbons,” or related terms refer to compounds comprising hydrogen and carbon atoms that do not have a phenolic functional group, which is a hydroxyl group (—OH) bonded to an aromatic hydrocarbon group. Illustrative, non-limiting hydrocarbon compounds include alkanes, alkenes, cycloalkanes and their alkyl substituents or derivatives, and cycloalkenes and their alkyl substituents or derivatives, which can be suitable for use in fuel composition, for instance gasoline or diesel. For instance, illustrative hydrocarbon compounds can include but are not limited to any one of cyclohexane, cyclohexene, propyl cyclopentane, propyl cyclopentene, propyl cyclohexane, propyl cyclohexene, anisole, propyl benzene, methyl propyl benzene, and oxygenated hydrocarbons such as cyclohexanone or methyl cyclohexanone.

Methods and systems described in this disclosure can provide for lignin reversion, e.g., reversion of lignin to phenols and conversion of phenolics derived from lignin to hydrocarbons. As mentioned, processing of cellulosic biomass can include hydrothermally digesting cellulosic biomass and carrying out a catalytic reduction reaction of soluble carbohydrates, including in one reactor. This can be achieved via in situ catalytic reduction reaction, which involves heating the cellulosic biomass and a digestion solvent in the presence of molecular hydrogen and a catalyst capable of activating molecular hydrogen. The hydrothermal digestion and catalytic reduction can generate a first reaction product comprising phenolics derived from lignin in the cellulosic biomass and an alcoholic component formed from a catalytic reduction reaction of soluble carbohydrates derived from the cellulosic biomass.

The term “alcoholic component” refers to an oxygenate where the oxygenate can be a monohydric alcohol, a glycol or diol, a triol, or any combination thereof. As used herein, the terms “glycol” or diol will refer to compounds containing two alcohol functional groups, two alcohol functional groups and a carbonyl functionality, or any combination thereof. It is understood that the alcoholic component also includes carbonyls that have carbonyl functionality. As used herein, the term “carbonyl functionality” will refer to an aldehyde functionality or a ketone functionality. In some embodiments, a glycol may comprise a significant fraction of the reaction product. Although a glycol may comprise a significant fraction of the reaction product, it is to be recognized that other alcohols, including triols and monohydric alcohols, for example, may also be present, as well as other oxygenates such as the ketone equivalent of the alcohol. Further, any of these alcohols may further include a carbonyl functionality.

As used herein, the term “triol” will refer to compounds containing three alcohol functional groups, three alcohol functional groups and a carbonyl functionality, and any combination thereof. As used herein, the term “monohydric alcohol” will refer to compounds containing one alcohol functional group, one alcohol functional group and a carbonyl functionality, and any combination thereof. The term “phenolics” or “phenols” has its ordinary meaning, which generally refers to a class of compounds that contain a hydroxyl group (—OH) bonded to an aromatic hydrocarbon group. The term “lignin oligomers” refers to a class of compounds with more than one lignin monomer, two or more aromatic rings, and a molecular weight of up to 300,000 Daltons. It is understood that lignin is a complex, amorphous, three-dimensional polymer having a structure based on phenylpropane. The molecular structure of lignin varies according to the source (e.g., type of plant) and is so complex and varied that its molecular structure has never been completely described. As such, lignin monomers and polymers can have various molecular structures. Commonly known lignin monomers include p-coumaryl alcohol, coniferyl alcohol, and sinapyl alcohol.

The in situ catalytic reduction reaction can be considered a first hydrothermal reaction step, which produces a first reaction product that may also be referred to as a digestion product. At least a portion of the phenolics in the first reaction product can optionally be converted to hydrocarbon compounds by a second hydrothermal reaction step where the first reaction product is heated in the presence of molecular hydrogen and catalyst capable activating molecular hydrogen. The reaction product from the second hydrothermal reaction step can be referred to as a second reaction product. Unless otherwise specified, the term “reaction product” can refer to the first reaction product or the second reaction product. Optionally, at least some of the alcoholic component in the first reaction product, such as glycol or triol, including carbonyls, can also be converted to monohydric alcohol in the second hydrothermal reaction step.

Unconverted phenolics—phenolics that have not been converted to hydrocarbons (meaning compounds that still contain a hydroxyl group bonded to an aromatic hydrocarbon group)—may be recycled or returned to at least one of the first hydrothermal reaction step and the second hydrothermal reaction step. The phenols may serve as part of the digestion solvent in the first hydrothermal reaction step, and/or the phenols may be further converted to hydrocarbons in the second hydrothermal reaction step. It has been found that, if employed, a second hydrothermal reaction step having a low phenolics concentration provides better yields of hydrocarbons from phenols, than one with a high concentration of phenolics, which limits the amount of water and other mono-oxygenated compounds available in the reaction. That is, lignin reversion is better when the concentration of phenolics in the reaction content of the second hydrothermal reaction step is low versus when the phenolics concentration is high. For instance, low phenolics concentration in the second hydrothermal reaction step is a concentration of up to 50% by weight based on the total weight of the content of the second hydrothermal reaction step. Non-limiting illustrative phenolics concentrations of the reaction content in the second hydrothermal reaction step can be in a range of about 0.1% and up to 50% by weight, and any amount in between, including up to 45%, up to 40%, up to 35%, up to 30%, up to 25%, up to 20%, up to 15%, up to 10%, or up to 5% by weight, based on the total content weight of the second hydrothermal reaction step. It is understood that the referenced any phenolics concentration amount in between 0.1 wt % to 50 wt % includes at least 5 wt %, at least 10 wt %, at least 15 wt %, at least 20 wt %, at least 25 wt %, at least 30 wt %, at least 35 wt %, at least 40 wt %, at least 45 wt %, or at least 50 wt %.

Lignin reversion, including conversion of lignin to phenols and/or conversion of phenolics to hydrocarbon compounds, can be improved if the conversion is accomplished in the presence of water. That is the overall phenolics concentration in the second hydrothermal reaction step of 50% or less by weight of the content of the second hydrothermal reaction step can be achieved at least in part with water. For instance, the concentration of water in the second hydrothermal reaction step can be at least 10% by weight based on the total weight of the content of the second hydrothermal reaction step. Non-limiting illustrative water concentration of the reaction content in the second hydrothermal reaction step can be at least 10%, at least 15%, at least 20%, at least 25%, at least 30%, at least 35%, or at least 40% by weight, based on the total content weight of the second hydrothermal reaction step. It is realized that the concentrations mentioned for the first or second hydrothermal reaction content are not limited to single liquid phase. Instead, the concentrations provided correspond to the concentrations of water averaged over all phases present in the respective reactor, where two or sometimes three or more liquid phases may be observed. Additional details regarding systems and methods related to lignin reversion can be found in U.S. application Ser. No. 14/868,426 filed on Sep. 29, 2015, claiming priority to application No. 62/058,440, filed on Oct. 1, 2014, entitled METHODS AND SYSTEMS FOR PROCESSING CELLULOSIC BIOMASS, the disclosure of which is incorporated by reference in its entirety.

At least a portion of the first and/or second reaction product can be provided to a separation zone that provides for liquid-liquid phase separation of the reaction product and product recovery of the phases independent of each other. Optionally, prior to being provided to the separation zone, excess gas in the reaction product can be removed. Liquid-liquid phase separation involves coalescing of the respective phases of the reaction product and isolation of those phases from each other. The liquid-liquid phase separation can provide an aqueous stream and a non-aqueous stream that can contain one or more non-aqueous phases. The aqueous stream comprises a major portion of the water present in the reaction product. The non-aqueous stream comprises the remaining portion of the reaction product not in the aqueous stream, which contains a minor portion of the water in the reaction product. Any suitable liquid-liquid phase separation methods and systems can be used to provide the aqueous stream and non-aqueous stream. These methods can be operated in batch mode, semi-batch mode, continuous mode, or any combination thereof. Non-limiting, illustrative methods and systems include a horizontal settling tank, one or more weirs, centrifuge- or hydroclone-type device, and devices that facilitate coalescing, including a fiber coalesce mat or a packed bed coalescer. Optionally, a portion of the non-aqueous stream can be recycled to the reaction product provided to the separation zone to improve the efficiency of the liquid-liquid phase separation.

In addition to water, the aqueous stream also comprises compounds that have some miscibility with water, including light compounds, middle-boiling compounds, and heavy compounds, as well as water-soluble salts, ash, tar, and other waste. Light compounds include those with a normal boiling point of less than 150 degrees C., including monohydric alcohols, aldehydes, ketones, acids, and any combination thereof. Middle-boiling compounds, such as those with a normal boiling point of 150 to 350 degrees C., which can be present in the aqueous stream include glycol and phenols. Heavy compounds include those with a normal boiling point of greater than 350 degrees C.

The light compounds can be recovered from the aqueous stream for further processing into desired products, such as fuel products. Any suitable method can be used to recover the light compounds from the aqueous stream. Non-limiting illustrative methods include one or more flashing steps. For instance, the aqueous stream can be subject to a first flashing step that recovers the light compounds and other desired compounds in the overhead fraction while the bottom fraction, which contains water-soluble salts, ash, tar, and other waste, which can be discarded as waste or processed as a byproduct stream for use in biogas generation, or as fuel for a utility boiler. An option of processing such waste or byproduct includes burning the material after removal of a portion of the water. Additionally or alternatively, instead of becoming waste, the bottom fraction of the first flashing step can be subject to a second flashing step to produce an overhead fraction that comprises middle-boiling compounds like glycols and phenols. The overhead fraction of the second flashing step comprising the middle-boiling compounds can be recovered and provided elsewhere in the process, such as in the first and/or second hydrothermal reaction step. The middle boiling compounds in the aqueous stream can serve as a solvent and/or be further reacted in the first and/or second hydrothermal reaction step. The bottom fraction of the second flashing step containing water-soluble salts, ash, tar, and other waste can be discarded, burned as fuel after partial water removal, or further processed to convert carboxylic acid salts to desirable byproducts. Separation of the reaction product into an aqueous stream and a non-aqueous stream also removes a portion of water-miscible waste or byproducts, including salts, ash, and tar, from the non-aqueous phase(s), which can provide for improved yields and reduced fouling and costs because the water-miscible waste would not be present during distillation of the non-aqueous stream.

The non-aqueous stream comprises a minor portion of water in the reaction product in the liquid-liquid phase separation unit. While the non-aqueous stream can still contain some water, it is referred to as “non-aqueous” to distinguish it from the aqueous stream that contains substantially more water. In addition to the small amount of water, the non-aqueous stream also comprises a major portion of middle-boiling compounds and a smaller amount of light compounds due to the miscibility of certain light compounds with the non-aqueous phase(s). After liquid-liquid phase separation, the non-aqueous stream can be distilled into various product fractions, including an overhead fraction comprising light compounds, a middle fraction comprising middle-boiling compounds, including phenols and lignin oligomers, and a bottom fraction comprising the heaviest of compounds in the reaction product, which are often regarded as waste or used as utility fuel. Additionally or alternatively, the non-aqueous stream can be distilled into more than one middle fraction.

Similar to the light compounds recovered from the aqueous fraction, the light compounds recovered from the distillation of the non-aqueous stream can be further processed into a fuels product. The light compounds recovered from each phase can be optionally combined prior to further processing. Similar to the middle-boiling compounds recovered from the aqueous fraction, the middle-boiling compounds recovered from the non-aqueous stream can be provided to the first and/or second hydrothermal reaction step. For instance, various compounds in the middle fraction(s), including phenols, can serve as solvent in the first hydrothermal reaction step. Additionally or alternatively, various compounds in the middle fraction(s), including phenols and lignin oligomers, can be further hydrotreated in the second hydrothermal reaction step. For instance, phenols in the middle fraction(s) can get converted to hydrocarbons in the second hydrothermal reaction step, and lignin oligomers in the middle fraction(s) can be further reverted to phenols in the second hydrothermal reaction step, particularly in the presence of water. While lignin oligomers can be provided to the first hydrothermal reaction step, it is not preferred.

As described, phenols serving as solvent in the first hydrothermal reaction step can come from products recovered from the aqueous stream and/or non-aqueous stream. Any suitable amount of recycled phenols—phenols coming from the reaction product—can be provided. In some circumstances, the amount of phenols provided to the first hydrothermal reaction step is a ratio of the amount of lignin provided thereto. For instance, phenols can be provided at a ratio of at least 1 part phenols to 2 parts lignin (1:2), including a ratio in a range of 1 part phenols to 2 parts lignin (1:2) to 10 parts phenols to 1 part lignin (10:1), or any ratio in between. Non-limiting illustrative ratios include at least 1 part phenols to 1 part lignin (1:1), 2 parts phenols to 1 part lignin (2:1), 3 parts phenols to 1 part lignin (3:1), 4 parts phenols to 1 part lignin (4:1), 5 parts phenols to 1 part lignin (5:1), 6 parts phenols to 1 part lignin (6:1), 7 parts phenols to 1 part lignin (7:1), 8 parts phenols to 1 part lignin (8:1), 9 parts phenols to 1 part lignin (9:1), 10 parts phenols to 1 part lignin (10:1), and any combination thereof. It is understood that lignin is provided as a component of the biomass feed, or via recycle of a process stream containing lignin.

If a second hydrothermal reaction step is present, glycols, phenols, and/or lignin oligomers can be provided to it. The glycols and phenols can be products recovered from the aqueous stream. The phenols and lignin oligomers can come from a middle fraction distilled from the non-aqueous stream. Any suitable amount of recycled phenols and/or lignin oligomers can be provided consistent with the low phenolics concentration of up to 50% by weight based on the total weight of the content of the second hydrothermal reaction step discussed above. The term “recycled” refers to compounds recovered from the reaction product.

Optionally, the non-aqueous stream can be subject to one or more lignin depolymerization reactions prior to distillation to reduce the viscosity of the non-aqueous stream, thereby improving the separation of the product fractions during distillation. Any suitable lignin depolymerization reaction can be used. In general, lignin depolymerization reactions revert high molecular weight lignin oligomers to lower molecular weight compounds, such as lighter lignin oligomers and/or lignin monomers, which results in viscosity reduction. Depolymerization of lignin in the non-aqueous stream provides lignin monomers that facilitate phenolics separation from the lignin oligomers and even heavier compounds. The lignin monomers can become a cutting agent to reduce the viscosity of the high molecular weight lignin oligomers. The middle fraction comprising phenols and/or lignin oligomers distilled from the non-aqueous stream can also be provided to the lignin depolymerization reactions to further reduce the viscosity of the feed into the distillation unit, thereby enhancing product separation. It is recognized that this step may necessarily involve use of less water and optionally can be conducted in the absence of catalyst, such that higher temperatures (in excess of 300° C.) may be required for effective conversion of lignin to smaller fragments of lower viscosity via this step.

The following paragraphs provide additional details of the provided methods and systems for processing cellulosic biomass into a fuel product, particularly processing of a reaction product obtained from hydrothermal reaction of cellulosic biomass solids. As mentioned above, hydrothermal reaction of a cellulosic biomass can include in situ catalytic reduction, which involves heating of the cellulosic biomass and a digestion solvent in the presence of molecular hydrogen and a catalyst capable of activating the molecular hydrogen. Any type of suitable catalyst capable of activating hydrogen can be used in any reactor suitable for use with the selected catalyst(s) for the first and/or second hydrothermal reaction step. For example, at least one of the first and second hydrothermal reaction steps can be carried out using fluidly mobile catalyst particles that can be at least partially suspended in a fluid phase via gas flow, liquid flow, mechanical agitation, or any combination thereof in a reactor. Various conditions can be implemented so that the fluidly mobile catalyst particles do not get carried out of the reactor by the fluid flowing through the reactor. A reactor operating under these circumstances can be called an ebullating bed reactor in part because the catalyst particles remain in the reactor to form a catalytic bed. It is understood that one of ordinary skill in the art can select the various conditions to achieve an ebullating bed reactor. For instance, a suitable concentration of catalyst and/or catalyst size can be selected to obtain the desired reactor conditions.

On the other hand, the conditions can be modified so that the fluidly mobile catalyst particles flow with the biomass solids through the reactor. A reactor operating under these circumstances can be called a slurry reactor. Adequate catalyst distribution is desirable in a slurry reactor so that soluble carbohydrates formed during hydrothermal digestion may be intercepted and converted into more stable compounds before they have had an opportunity to significantly degrade, even under thermal conditions that otherwise promote their degradation.

If present, the second hydrothermal reaction step can also be carried out using a catalyst that does not comprise fluidly mobile catalyst particles. For example, the second hydrothermal reaction step can be carried out in a fixed bed reactor or a trickle bed reactor, which are known by one of ordinary skill in the art. For instance, during operation of a fixed bed or trickle bed reactor and fluid is flowing through the reactor, the height of the bed does not increase to greater than 10% as compared to when fluid is not flowing through the reactor.

If a reactor with a catalyst that does not comprise fluidly mobile catalyst particles is used in the second hydrothermal reaction step, a possible issue may be clogging of the bed by cellulosic particulates in the first reaction product from the digestion. As cellulosic biomass breaks apart during digestion, smaller and smaller particulates may be produced until only insoluble materials remain. Cellulosic particulates may also be present in native cellulosic biomass before digestion takes place. One way of handling cellulosic particulates can be use of a screen at a fluid outlet of the hydrothermal digestion unit to assist in maintaining the cellulosic fines therein. Periodic backflow or “backflush” of liquid or gas may be necessary to flush solids from this screen, to maintain fluid outflow. At a certain size, the cellulosic particulates may pass through the screen of the hydrothermal digestion unit and enter at least the reactor in the second reaction zone.

Another way to address cellulosic particulates, particularly ones that are sufficiently small to pass through screens, is the methods and systems disclosed in commonly owned U.S. Application Publication No. 2013/0152456 (“the '456 publication”), the disclosure of which is incorporated herein in its entirety. In general, the '456 publication discloses a solids separation unit to which the first reaction product can be routed to have at least a portion of the cellulosic particulates removed before it enters a reactor in the second reaction zone. The solids separation unit can comprise one or more filters, where at least one of the filters can be backflushed to remove cellulosic fines therefrom, while one or more of the other filters remain in fluid communication with an inlet of the reactor in the second reaction zone.

In some embodiments, catalysts capable of activating molecular hydrogen may comprise a metal such as, for example, Cr, Mo, W, Re, Mn, Cu, Cd, Fe, Co, Ni, Pt, Pd, Rh, Ru, Ir, Os, and alloys or any combination thereof, either alone or with promoters such as Au, Ag, Cr, Zn, Mn, Sn, Bi, B, O, and alloys or any combination thereof. In some embodiments, the catalysts and promoters may allow for various hydrothermal reactions, such as hydrogenation and hydrogenolysis reactions, to occur at the same time or in succession of one another. In some embodiments, such catalysts may also comprise a carbonaceous pyropolymer catalyst containing transition metals (e.g., Cr, Mo, W, Re, Mn, Cu, and Cd) or Group VIII metals (e.g., Fe, Co, Ni, Pt, Pd, Rh, Ru, Ir, and Os). In some embodiments, the foregoing catalysts may be combined with an alkaline earth metal oxide or adhered to a catalytically active support. In some or other embodiments, the catalyst capable of activating molecular hydrogen may be deposited on a catalyst support that is not itself catalytically active.

In some embodiments, the catalyst used in the first and/or second hydrothermal reaction step may comprise a poison-tolerant catalyst. As used herein the term “poison-tolerant catalyst” refers to a catalyst that is capable of activating molecular hydrogen without needing to be regenerated or replaced due to low catalytic activity for at least about 12 hours of continuous operation. Use of a poison-tolerant catalyst may be particularly desirable when reacting soluble carbohydrates derived from cellulosic biomass solids that have not had catalyst poisons removed therefrom. Catalysts that are not poison tolerant may also be used to achieve a similar result, but they may need to be regenerated or replaced more frequently than does a poison-tolerant catalyst.

Suitable poison-tolerant catalysts may include, for example, sulfided catalysts. In some or other embodiments, nitrided catalysts may be used as poison-tolerant catalysts. Sulfided catalysts suitable for activating molecular hydrogen are described in commonly owned U.S. patent application Ser. No. 13/495,785, and 61/553,591, each of which is incorporated herein by reference in its entirety.

The catalyst particles may have a particulate size of about 250 microns or less, about 100 microns or less, or about 10 microns or less. The minimum particulate size of the catalyst particles may be about 1 micron. The catalyst particles may comprise catalyst fines. As used herein, the term “catalyst fines” refers to solid catalysts having a nominal particulate size of about 100 microns or less. Catalyst fines may be generated from catalyst production processes, for example, during extrusion of solid catalysts. Catalyst fines may also be produced by grinding larger catalyst solids or during regeneration of catalyst solids. Suitable methods for producing catalyst fines are described in U.S. Pat. Nos. 6,030,915 and 6,127,229, each of which is incorporated herein by reference in its entirety. In some instances, catalyst fines may be intentionally removed from a solid catalyst production run, since they may be difficult to sequester in some catalytic processes. Techniques for removing catalyst fines from larger catalyst solids may include, for example, sieving or like size separation processes. When conducting in situ catalytic reduction reaction processes, such as those described herein, catalyst fines may be particularly well suited, since they can be easily fluidized and distributed in the interstitial pore space of the digesting cellulosic biomass solids.

Catalysts that are not particularly poison-tolerant may also be used in conjunction with the techniques described herein. Such catalysts may include, for example, Ru, Pt, Pd, or compounds thereof disposed on a solid support such as, for example, Ru on titanium dioxide or Ru on carbon. Although such catalysts may not have particular poison tolerance, they may be regenerable, such as through exposure of the catalyst to water at elevated temperatures, which may be in either a subcritical state or a supercritical state.

The catalysts used in conjunction with the processes described herein may be operable to generate molecular hydrogen. For example, in some embodiments, catalysts suitable for aqueous phase reforming (i.e., APR catalysts) may be used. Suitable APR catalysts may include, for example, catalysts comprising Pt, Pd, Ru, Ni, Co, or other Group VIII metals alloyed or modified with Re, Mo, Sn, or other metals. Thus, in some embodiments described herein, an external hydrogen feed may not be needed in order to effectively carry out the stabilization of soluble carbohydrates by a catalytic reduction reaction. However, in other embodiments, an external hydrogen feed may be used, optionally in combination with internally generated hydrogen. In yet other embodiments, the molecular hydrogen needed may be externally supplied to the cellulosic biomass solids. If external hydrogen is provided, the molecular hydrogen may be supplied as an upwardly directed fluid stream. Benefits of supplying an upwardly directed fluid stream are described herein.

The digestion solvent provided to the first reaction zone may comprise an organic solvent. In various embodiments, the digestion solvent may comprise an organic solvent and water. Although any organic solvent that is at least partially miscible with water may be used in the digestion solvent, particularly advantageous organic solvents are those that can be directly converted into fuel blends and other materials without being separated from the alcoholic component. That is, particularly advantageous organic solvents are those that may be co-processed during downstream further processing reactions with the alcoholic component being produced. Suitable organic solvents in this regard may include, for example, ethanol, ethylene glycol, propylene glycol, glycerol, phenols, and any combination thereof. Other suitable organic solvents may include sugar alcohols, for example.

In some embodiments, the digestion solvent may further comprise a small amount of a monohydric alcohol. The presence of at least some monohydric alcohols in the digestion solvent may desirably enhance the digestion and/or the catalytic reduction reactions being conducted therein. For example, inclusion of about 1% to about 5% by weight monohydric alcohols in the digestion solvent may desirably maintain catalyst activity due to a surface cleaning effect. At higher concentrations of monohydric alcohols, bulk solvent effects may begin to predominate. In some embodiments, the digestion solvent may comprise about 10 wt. % or less monohydric alcohols, with the balance of the digestion solvent comprising water and another organic solvent. In some embodiments, the digestion solvent may comprise about 5 wt. % or less monohydric alcohols, or about 4% or less monohydric alcohols, or about 3% or less monohydric alcohols, or about 2% of less monohydric alcohols, or about 1% or less monohydric alcohols. Monohydric alcohols present in the digestion solvent may arise from any source. In some embodiments, the monohydric alcohols may be formed as a co-product with the alcoholic component being formed by the catalytic reduction reaction. In some or other embodiments, the monohydric alcohols may be formed by a subsequent catalytic reduction of the initially produced alcoholic component and thereafter returned to the cellulosic biomass solids. In still other embodiments, the monohydric alcohols may be sourced from an external feed that is in flow communication with the cellulosic biomass solids.

In some embodiments, the digestion solvent may comprise between about 1% water and about 99% water, with the organic solvent comprising the balance of the digestion solvent composition. Although higher percentages of water may be more favorable from an environmental standpoint, higher quantities of organic solvent may more effectively promote hydrothermal digestion due to the organic solvent's greater propensity to solubilize carbohydrates and promote catalytic reduction of the soluble carbohydrates. In some embodiments, the digestion solvent may comprise about 90% or less water by weight. In other embodiments, the digestion solvent may comprise about 80% or less water by weight, or about 70% or less water by weight, or about 60% or less water by weight, or about 50% or less water by weight, or about 40% or less water by weight, or about 30% or less water by weight, or about 20% or less water by weight, or about 10% or less water by weight, or about 5% or less water by weight.

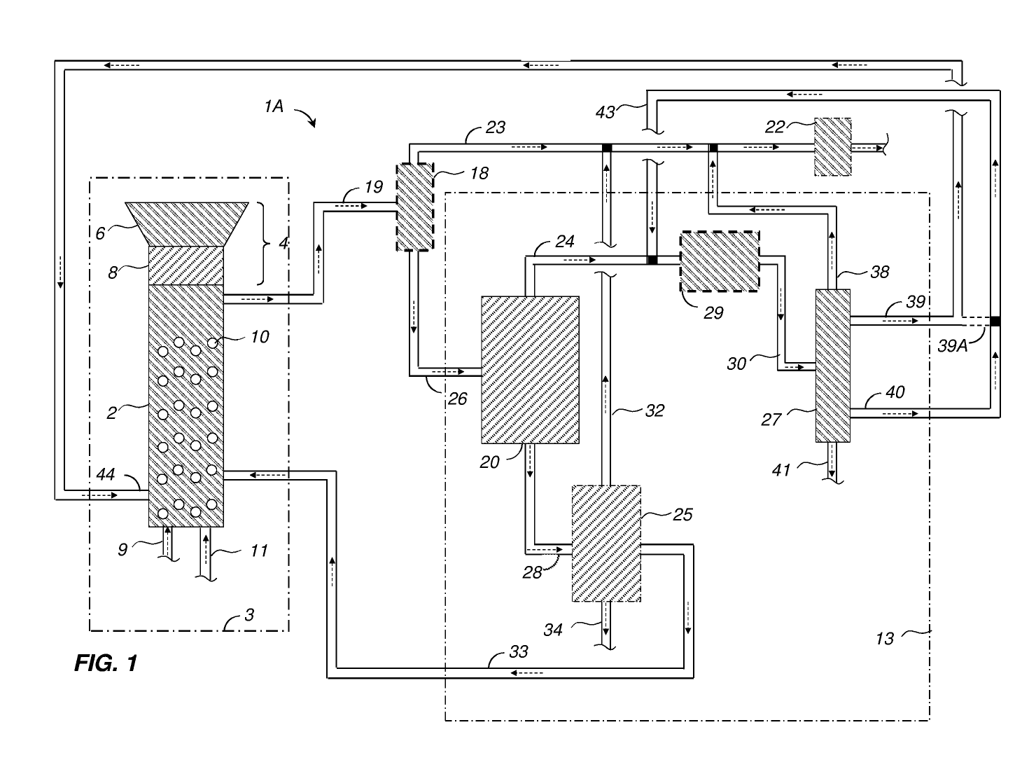

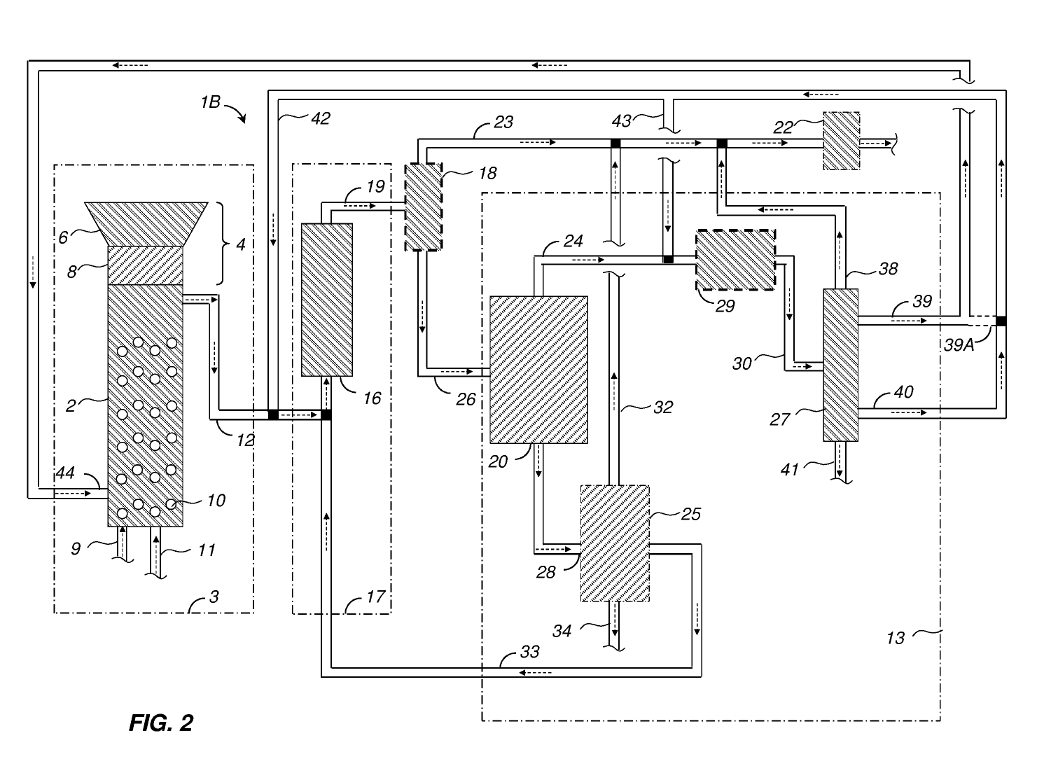

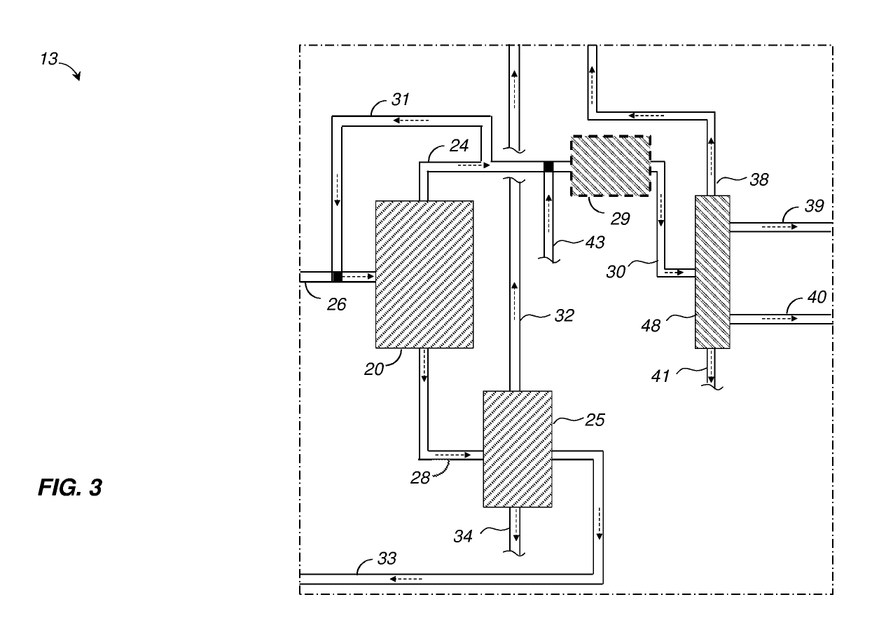

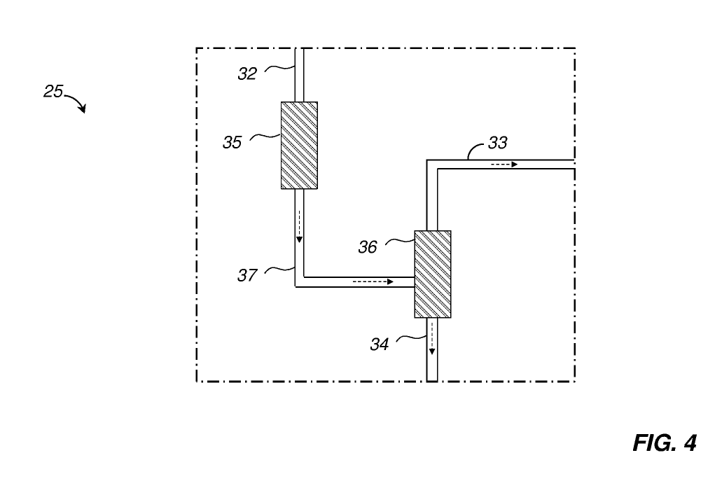

Various illustrative embodiments will be further described with reference to FIGS. 1-4. In particular, FIGS. 1-2 show two illustrative embodiments of biomass processing system 1, specifically system 1A in FIG. 1 and system 1B in FIG. 2. FIG. 3 shows an embodiment of separation zone 13 that can be employed in a system or method to process cellulosic biomass as provided in the present disclosure, such as biomass processing system 1, as depicted in either FIG. 1 or 2. FIG. 4 shows an embodiment of aqueous stream separation zone 25 that can be employed in a separation zone in a system or method to process cellulosic biomass as provided by the present disclosure, such as in separation zone 13 of system 1 depicted in FIG. 1, 2, or 3.

Referring to FIGS. 1-3, hydrothermal digestion unit 2 in first reaction zone 3, which can also be referred to as digestion zone 3, contains a first reaction content comprising cellulosic biomass, a catalyst capable of activating molecular hydrogen, a digestion solvent, and molecular hydrogen. As further discussed below, the first reaction content subsequent to the initial materials provided to hydrothermal digestion unit 2 can further comprise a recycled phenolic portion that may be part of the digestion solvent. While FIGS. 1-2 show one hydrothermal digestion unit 2 in digestion zone 3, it is understood that digestion zone 3 can comprise any suitable number of hydrothermal digestion unit coupled to one another (e.g., in fluid communication with one another), such as at least two, three, four, five, six, or more hydrothermal digestion units. The catalyst capable of activating molecular hydrogen provided to hydrothermal digestion unit 2 preferably comprises fluidly mobile catalyst particles 10. For instance, hydrothermal digestion unit 2 can be a slurry reactor or an ebullating bed reactor. In the interest of clarity, the cellulosic biomass, digestion solvent, and molecular hydrogen in hydrothermal digestion unit 2 have not been depicted. If reaction zone 3 has more than one hydrothermal digestion units, these units can be any combination of a slurry reactor and/or an ebullating bed reactor.

The reaction content in hydrothermal digestion unit 2 is heated to form a first reaction product comprising phenols and an alcoholic component. The phenols are derived from lignin in the cellulosic biomass, and the alcoholic component is formed from soluble carbohydrates derived from cellulosic biomass. Heating of the first reaction content provides for in situ catalytic reduction where digestion of the cellulosic biomass and catalytic reduction of soluble carbohydrates takes place in the same reactor. The reaction content in hydrothermal digestion unit 2 is heated to a temperature that may be in a range of about 190 to 260 degrees C., such as in a range of about 225 to 245 degrees C. For instance, the reaction content in hydrothermal digestion unit 2 can be heated to about 190, 195, 200, 205, 210, 215, 220, 225, 230, 235, 240, 245, 250, 255, or 260 degrees C.

The heating of the first reaction content in hydrothermal digestion unit 2 is preferably performed under a pressurized state. As used herein, the term “pressurized state” refers to a pressure that is greater than atmospheric pressure (1 bar). For example, hydrothermal digestion unit 2 may have a pressure of at least about 30 bar, such as at least about 45 bar, at least about 60 bar, at least about 75 bar, at least about 90 bar, at least about 100 bar, at least about 110 bar, at least about 120 bar, or at least about 130. Hydrothermal digestion unit 2 may have a pressure of at most about 450 bar, such as at most about 330 bar, at most about 200 bar, at most about 175 bar, at most about 150 bar, or at most about 130 bar. As such, hydrothermal digestion unit 2 may have a pressure in a range of about 30 to 450 bar, such as a range of about 45 and 330 bar or in a range of about 75 to 130 bar. Hydrogen is preferably added to achieve the desired total pressure of hydrothermal digestion unit 2. For instance, hydrogen partial pressure of greater than 5 bar, greater than 10, or greater than 25 bar can be provided to hydrothermal digestion unit 2 to achieve the desired total pressure. Additional pressure may occur from vaporization of a portion of the water and volatile compounds of the reaction content. Heating of the digestion solvent in hydrothermal digestion unit 2 in a pressurized state may allow the normal boiling point of various compounds of the digestion solvent to be exceeded, thus allowing a predominately liquid state to be maintained, thereby allowing the rate of hydrothermal digestion to be increased relative to lower temperature digestion processes.

The reaction content in hydrothermal digestion unit 2 may be heated for at least 30 minutes and up to 10 hours, most typically between 120 minutes to 300 minutes. For example, digestion may be carried out for at least 30 minutes, at least 60 minutes, at least 120 minutes, at least 180 minutes, at least 240 minutes, at least 300 minutes, at least 360 minutes, at least 420 minutes, at least 480 minutes, at least 540 minutes, or at least 600 minutes. Digestion may be carried out at most 600 minutes, at most 540 minutes, at most 480 minutes, at most 420 minutes, at most 360 minutes, at most 300 minutes, at most 240 minutes, at most 180 minutes, at most 120 minutes, at most 60 minutes, or at most 30 minutes.

Referring to FIGS. 1-2, hydrothermal digestion unit 2 may be charged with a desired amount of catalyst particulates 10, while cellulosic biomass solids are continuously or semi-continuously added thereto at a more frequent rate, thereby allowing hydrothermal digestion to take place in a continual manner. Catalyst solids may be periodically withdrawn and replaced with fresh catalyst, to compensate for degradation of catalyst during operation, or poisoning via components in the biomass feed. Cellulosic biomass may be introduced to hydrothermal digestion unit 2 in the first reaction zone via solids introduction mechanism 4. As used herein, the term “continuous addition” and grammatical equivalents thereof will refer to a process in which cellulosic biomass solids are added to a hydrothermal digestion unit in an uninterrupted manner without fully depressurizing the hydrothermal digestion unit. As used herein, the term “semi-continuous addition” and grammatical equivalents thereof will refer to a discontinuous, but as-needed, addition of cellulosic biomass solids to a hydrothermal digestion unit without fully depressurizing the hydrothermal digestion unit. That is, fresh cellulosic biomass solids may be added to hydrothermal digestion unit 2 on a continual or an as-needed basis in order to replenish cellulosic biomass solids that have been digested to form soluble carbohydrates.

Solids introduction mechanism 4 may comprise loading mechanism 6 and pressure transition zone 8, which may continuously or periodically elevate the cellulosic biomass from atmospheric pressure to a pressure near that of the operating pressure of hydrothermal digestion unit 2, particularly when hydrothermal digestion unit 2 is in a pressurized state. This allows for continuous or semi-continuous introduction of cellulosic biomass to take place without fully depressurizing hydrothermal digestion unit 2. That is, the cellulosic biomass solids may be continuously or semi-continuously added to the hydrothermal digestion unit while the hydrothermal digestion unit is in a pressurized state. Without the ability to introduce fresh cellulosic biomass to a pressurized hydrothermal digestion unit, depressurization and cooling of the hydrothermal digestion unit may take place during biomass addition, significantly reducing the energy- and cost-efficiency of the biomass conversion process.

Pressure transition zone 8 may comprise one or more suitable pressurization zones for pressurizing and introducing cellulosic biomass solids to hydrothermal digestion unit 2. Such suitable pressurization zones are described in more detail in commonly owned United States Patent Application Publications 2013/0152457 and 2013/0152458, and incorporated herein by reference in their entirety. Another suitable example of an illustrative pressure transition zone is described in more detail in commonly owned U.S. patent application Ser. No. 14/868,448, which claims priority to Application No. 62/058,177, filed on Oct. 1, 2014, entitled SYSTEMS AND METHODS FOR PROVIDING FEED MATERIAL TO A PRESSURIZED SYSTEM, which is incorporated herein by reference in its entirety. Suitable pressurization zones described therein may include, for example, pressure vessels, pressurized screw feeders, one or more pumps capable of pumping solids and solids slurries, and the like. Multiple pressurization zones may be connected in series to increase the pressure of the cellulosic biomass solids in a stepwise manner.

In various embodiments, soluble carbohydrates produced from cellulosic biomass solids may be converted into a reaction product comprising a glycol via a catalytic reduction reaction mediated by a catalyst that is capable of activating molecular hydrogen. As described in commonly owned U.S. Patent Applications 61/720,704 and 61/720,714, entitled “Methods for Production and Processing of a Glycol Reaction Product Obtained from Hydrothermal Digestion of Cellulosic Biomass Solids” and “Methods for Conversion of a Glycol Reaction Product Obtained from Hydrothermal Digestion of Cellulosic Biomass Solids Into a Dried Monohydric Alcohol Feed,” each filed Oct. 31, 2012 and incorporated herein by reference in its entirety, production of glycols may present several process advantages, particularly with regard to downstream further processing reactions. In other aspects, formation of monohydric alcohols may be more desirable.

Referring to FIGS. 1-2, catalyst particulates 10 are capable of activating molecular hydrogen. At least a portion of catalyst particulates 10 may be distributed in the cellulosic biomass, particularly in hydrothermal digestion unit 2. If in situ catalytic reduction is carried out, effective distribution of catalyst particulates 10 throughout cellulosic biomass solids for in situ catalytic reduction reaction is desired. This may be achieved by using fluid flow to convey catalyst particulates 10 into the interstitial spaces within a charge of cellulosic biomass solids. As used herein, the terms “distribute,” “distribution,” and variants thereof refer to a condition in which catalyst particulates are present at all heights of a charge of cellulosic biomass. No particular degree of distribution is implied by use of the term “distribute” or its variants. Catalyst distribution may comprise a substantially homogeneous distribution, such that a concentration of catalyst particulates is substantially the same at all heights of a cellulosic biomass charge. Catalyst distribution may comprise a heterogeneous distribution, such that different concentrations of catalyst particulates are present at various heights of the cellulosic biomass charge. When a heterogeneous distribution of catalyst particulates is present, a concentration of catalyst particulates in the cellulosic biomass solids in hydrothermal digestion unit 2 may increase from top to bottom or decrease from top to bottom. In some embodiments, a heterogeneous distribution may comprise an irregular concentration gradient.

Catalyst particulates 10 may be conveyed into the cellulosic biomass solids in hydrothermal digestion unit 2 for distribution using fluid flow from any direction. In particular, at least a portion of catalyst particulates 10 may be conveyed by upwardly directed fluid flow, or at least that upwardly directed fluid flow be present. For instance, catalyst particulates 10 may be supplied through fluid inlet line 9 as shown in FIGS. 1-2. Such upwardly directed fluid flow may promote expansion of the cellulosic biomass solids and disfavor gravity-induced compaction that occurs during their addition and digestion. In addition, when upwardly directed fluid flow is present, there may be a reduced need to utilize mechanical stirring or like mechanical agitation techniques that might otherwise be needed to obtain an adequate catalyst distribution.

Suitable techniques for using fluid flow to distribute catalyst particulates 10 within cellulosic biomass solids are described in commonly owned U.S. Patent Applications 61/665,727 and 61/665,627, each filed on Jun. 28, 2012 (PCT/US2013/048239 and PCT/US2013/048248) and incorporated herein by reference in its entirety. As described therein, cellulosic biomass solids may have at least some innate propensity for retaining catalyst particulates 10 being conveyed by fluid flow, and at least a portion of the cellulosic biomass solids may be sized to better promote such retention. In addition, using fluid flow, particularly upwardly directed fluid flow, to force catalyst particulates 10 to actively circulate through a charge of digesting cellulosic biomass solids may ensure adequate catalyst distribution as well as advantageously reduce thermal gradients that may occur during hydrothermal digestion. As a further advantage, active circulation of catalyst particulates 10 may address the problem created by the production of cellulosic biomass fines, since they may be co-circulated with catalyst particulates for continued digestion to take place in hydrothermal digestion unit 2.

The upwardly directed fluid flow may comprise a gas stream, a liquid stream, or any combination thereof. Also, the upwardly directed fluid flow may comprise one upwardly directed fluid stream, or two upwardly directed fluid streams, or three upwardly directed fluid streams, or four upwardly directed fluid streams, or five upwardly directed fluid streams.

At least some of the one or more upwardly directed fluid streams may contain catalyst particulates at its source. That is, the fluid stream(s) may comprise a stream of catalyst particulates. The one or more upwardly directed fluid streams may convey catalyst particulates therein. In other circumstances, the one or more upwardly directed fluid streams may not contain catalyst particulates at its source, but they may still fluidize catalyst particulates located in or near the cellulosic biomass solids.

The one or more upwardly directed fluid streams may comprise a gas stream. For example, a gas stream being used for upwardly directed fluid flow may comprise a stream of molecular hydrogen. Steam, or an inert gas such as nitrogen, for example, may be used in place of or in addition to a stream of molecular hydrogen. Up to about 40% steam may be present in the fluid stream.

The one or more upwardly directed fluid streams may comprise a liquid stream, particularly when it is not necessarily desired to maintain catalyst particulates in the cellulosic biomass solids and/or a gas stream alone is insufficient to distribute catalyst particulates, for example. Unlike a gas stream, a liquid stream may convey catalyst particulates through the cellulosic biomass solids, add to the liquid head surrounding the cellulosic biomass solids, and eventually spill over. In other circumstances, catalyst fluidization may be incomplete, and a liquid stream may still not convey catalyst particulates completely through the cellulosic biomass solids before the liquid head spills over.

As such, in certain instances, at least a portion of the liquid head may be circulated through the cellulosic biomass solids. Suitable hydrothermal digestion units configured for circulating a liquid phase therethrough, such as hydrothermal digestion unit 2 depicted in FIGS. 1-2, are described in commonly owned U.S. Patent Application 61/665,717, filed on Jun. 28, 2012 (PCT/US2013/048212) and incorporated herein by reference in its entirety. Specifically, hydrothermal digestion unit 2 may comprise a fluid circulation loop through which the liquid phase and optionally catalyst particulates 10 are circulated for distribution in the cellulosic biomass solids.

Another way to distribute catalyst particulates 10 is to convey at least a portion comprising phenols in hydrothermal digestion unit 2 to a point above at least a portion of the cellulosic biomass solids and release that portion. Catalyst particulates 10 can have the tendency to accumulate and agglomerate in larger particles in presence of phenols, particularly if the phenols aggregate to form a phenols-rich liquid phase, which contains a major portion of the phenols in unit 2. The formation of the phenols-rich liquid phase provides a catalyst-rich fraction, which contains a major portion of catalyst in unit 2, above cellulosic biomass solids in hydrothermal digestion unit 2, which can act to release catalyst particulates for downward percolation through the cellulosic biomass solids. Techniques for downward percolation of catalyst particulates and phenols are described in commonly owned U.S. Patent Application No. 61/720,757 filed Oct. 31, 2012, entitled “Methods and Systems for Distributing a Slurry Catalyst in Cellulosic Biomass Solids” and U.S. Patent Publication No. 20140174432, filed on Dec. 17, 2013, the disclosures of which are incorporated herein by reference in their entirety.

In the embodiment of system 1 shown in FIG. 1, the first reaction product from hydrothermal digestion unit 2 may be provided to separation zone 13. FIG. 2 shows another embodiment of system 1—system 1B—where the first reaction product is provided via line 12 to phenolics conversion unit 16 in a second reaction zone, zone 17. While FIG. 2 shows one phenolics conversion unit 16 in reaction zone 17, it is understood that reaction zone 17 can comprise any suitable number of reactors coupled to one another (e.g., in fluid communication with one another), such as at least two, three, four, five, six, or more phenolics conversion units. Phenolics conversion unit 16 produces a second reaction product that is provided to separation zone 13. A portion of the diols and glycols present in digestion product 12 can also be converted to desired monooxygenated intermediates, such as light compounds, including monohydric alcohols (e.g., mono-oxygenates), aldehydes, ketones, acids, via conversion unit 16.

As shown in FIG. 2, the first reaction product is optionally part of a second reaction content that is provided t2o phenolics conversion unit 16. The second reaction content further comprises catalyst capable of activating molecular hydrogen, and molecular hydrogen. As further discussed below, the second reaction content subsequent to the initial materials provided to phenolics conversion unit 16 can also further comprise a phenolics portion. The second reaction content is heated in phenolics conversion unit 16 to form a second reaction product comprising unconverted phenolics, hydrocarbons converted from phenolics. Optionally, the second reaction product can also comprise monohydric alcohols converted from triols and glycol in the alcoholic component in the first reaction product.

Referring to FIG. 2, heating of the second reaction content in phenolics conversion unit 16 hydrotreat compounds in the first reaction product that are hydrotreatable but had not been hydrotreated in hydrothermal digestion unit 2. In particular, heating of the second reaction content provides for conversion of at least a portion of the phenolics in phenolics conversion unit 16 to hydrocarbons, and optionally, conversion of at least a portion of triol and glycol to monohydric alcohol. The reaction content in phenolics conversion unit 16 is heated to a temperature that may be in a range of about 210 to 300 degrees C., such as in a range of 270 to 290 degrees C. or at least 270 degrees C. For instance, the reaction content in phenolics conversion unit can be heated to about 210, 215, 220, 225, 230, 235, 240, 245, 250, 255, 260, 265, 270, 275, 280, 285, 290, 295, or 300 degrees C. In a particular embodiment, a temperature of the second reaction product at an outlet of phenolics conversion unit 16 is greater than a temperature of the first reaction product at an outlet of hydrothermal digestion unit 2. The hydrotreating of the second reaction content in phenolics conversion unit 16 can also provide for regeneration of catalyst particulates accumulated in the first reaction product, if they are present.

In FIG. 2, phenolics conversion unit 16 is preferably in a pressurized state. For example, phenolics conversion unit 16 may have a pressure of at least about 30 bar, such as at least about 45 bar, at least about 60 bar, at least about 75 bar, at least about 90 bar, at least about 100 bar, at least about 110 bar, at least about 120 bar, or at least about 130. Phenolics conversion unit 16 may have a pressure of at most about 450 bar, such as at most about 330 bar, at most about 200 bar, at most about 175 bar, at most about 150 bar, or at most about 130 bar. As such, phenolics conversion unit 16 may have a pressure in a range of about 30 to 450 bar, such as a range of about 45 and 330 bar or in a range of about 75 to 130 bar. Hydrogen is preferably used to achieve the desired total pressure of phenolics conversion unit 16. For instance, hydrogen partial pressure of greater than 5 bar, greater than 10, or greater than 25 bar can be provided to phenolics conversion unit 16 to achieve the desired total pressure.

Referring to FIG. 2, the reaction content in phenolics conversion unit 16 may be heated for at least 30 minutes and up to 10 hours, such as 120 minutes to 300 minutes. For example, digestion may be carried out for at least 30 minutes, at least 60 minutes, at least 120 minutes, at least 180 minutes, at least 240 minutes, at least 300 minutes, at least 360 minutes, at least 420 minutes, at least 480 minutes, at least 540 minutes, or at least 600 minutes. Digestion may be carried out at most 600 minutes, at most 540 minutes, at most 480 minutes, at most 420 minutes, at most 360 minutes, at most 300 minutes, at most 240 minutes, at most 180 minutes, at most 120 minutes, at most 60 minutes, or at most 30 minutes.

The hydrothermal reaction carried out in phenolics conversion unit 16 can provide for conversion of lignin-derived phenolics into desirable hydrocarbons that can be used in a fuel blends, such as gasoline. Illustrative, non-limiting hydrocarbon compounds include alkanes, alkenes, cycloalkanes and their alkyl substituents or derivatives, and cycloalkenes and their alkyl substituents or derivatives, which can be suitable for use in fuel composition, for instance gasoline or diesel. For instance, illustrative hydrocarbon compounds can include but are not limited to any one of cyclohexane, cyclohexene, propyl cyclopentane, propyl cyclopentene, propyl cyclohexane, propyl cyclohexene, anisole, propyl benzene, oxygenated hydrocarbons cyclohexanone or methyl cyclohexanone, and methyl propyl benzene. The conversion of lignin derived phenolics into desirable hydrocarbons may not be complete, which can leave unconverted phenolics still remaining in the second reaction product. Optionally, the hydrothermal reaction carried out in phenolics conversion unit 16 can also provide for hydrodeoxygenation where triols and glycol of the alcoholic component are converted to monohydric alcohol. The hydrodeoxygenation may not be complete, which can leave triols and glycol still remaining in the second reaction product. As such, the second reaction product can comprise unconverted phenolics, hydrocarbons converted from phenolics, and at least a portion of the alcoholic component.

In phenolics conversion unit 16, phenols can also be converted to a cyclic alcohol, including at least one of alkyl cyclohexanols and alkyl cyclopentanols. Operating conditions of phenolics conversion unit 16 can be selected to generate relatively more of certain phenols-derived cyclic alcohols, thereby leaving less phenols in the second reaction content in unit 16. At least one of cyclohexanol and cyclopentanol can also be formed from carbohydrates in hydrothermal digestion unit 2 and phenolics conversion unit 16, if present, via hydrodeoxygenation reactions in the presence of a catalyst capable of activating molecular hydrogen.

As mentioned, it has been found that a second hydrothermal reaction step, which takes in reaction zone 17, such as in phenolics conversion unit 16 of FIG. 2, with a low phenolics concentration provides better yields of hydrocarbons than one with a high concentration of phenolics. Phenolics concentration in unit 16 includes a concentration of up to 50% by weight based on the total weight of the content of phenolics conversion unit 16. Non-limiting illustrative phenolics concentrations of the reaction content of unit 16 can be in a range of about 0.1% to 50% by weight, and any amount in between, including less than 45%, less than 40%, less than 35%, less than 30%, less than 25%, less than 20%, less than 15%, less than 10%, or less than 5% by weight, based on the total content weight of the second hydrothermal reaction step.

Also mentioned was that conversion of lignin to phenols and/or conversion of phenolics to hydrocarbon compounds can be improved if the conversion is accomplished in the presence of water. Referring to FIG. 2, phenolics concentration in unit 16 of 50% or less by weight of the content in unit 16 can be achieved at least in part with water. For instance, the concentration of water in phenolics conversion unit 16 can be at least 10% by weight based on the total weight of the content of unit 16. Non-limiting illustrative water concentration of the reaction content in phenolics conversion unit 16 can be at least 10%, at least 15%, at least 20%, at least 25%, at least 30%, at least 35%, or at least 40% by weight, based on the total content weight of the second hydrothermal reaction step.

FIGS. 1 and 2 show gas separator unit 18, which is optional. In FIG. 1, the first reaction product is provided to gas separator unit 18 via line 19. In FIG. 2, the second reaction product is provided to gas separator unit 18 via line 19. Gas separator unit 18 allows for removal of excess gas in the reaction product, as desired or needed. As discussed above, the first reaction product from hydrothermal thermal digestion unit 2 and the second reaction product from phenolics conversion unit 16 are provided to gas separator unit 18 under pressure because the respective unit 2 and unit 16 are operated in a pressurized state. As such, excess gas can be released from the reaction product by keeping gas separator unit 18 under the same pressure as or reduced pressure compared to hydrothermal digestion unit for system 1A in FIG. 1, or under the same pressure as or reduced pressure compared to phenolics conversion unit 16 for system 1B in FIG. 2. As shown in FIGS. 1-2, the excess gas can be provided to further processing zone 22 via line 23. A major portion of the excess gas comprises hydrogen and other compounds with a normal boiling point of less than 100 degrees C., including methane, carbon dioxide, carbon monoxide, and water). Other compounds, such as light mono-oxygenates, particularly less than C4 may be present in the excess gas, where this stream may provide addition material for conversion to a fuels product in further processing zone 22. The pressure of gas separator unit 18 can be selected based on considerations of the desired or selected operating pressure of liquid-liquid phase separation unit 20 in separation zone 13 and/or the desired or selected operating pressure of further processing zone 22. For instance, one consideration to not depressurize the reaction product in gas separator unit 18 below a certain amount is the need to repressurize products coming out of separation zone 13 intended for further processing zone 22. As such, it is understood that the pressure of gas separator unit 18 may be dependent on the pressure of other units and/or zones in system 1A or 1B. Non-limiting illustrative examples of a pressure of gas separator unit 18 can be in a range of about 5 to 50 bar, including 10 bar, 15 bar, 20 bar, 25 bar, 30 bar, 35 bar, 40 bar, or 45 bar.

As mentioned, gas separator unit 18 is optional so the first reaction product or the second reaction product can be provided to separation zone 13 from hydrothermal digestion unit 2 or phenolics conversion unit 16, respectively, without going through gas separator unit 18. Referring to FIGS. 1-3, separation zone 13 comprises liquid-liquid phase separation unit 20, aqueous stream separation zone 25, non-aqueous stream distillation unit 27, and optionally lignin depolymerization unit 29. In liquid-liquid phase separation unit 20, the reaction product provided via line 26 is separated into an aqueous stream depicted as line 28 and a non-aqueous depicted as line 24. The aqueous stream in line 28 is provided to aqueous stream separation zone 25. The non-aqueous stream in line 24 is provided to non-aqueous stream distillation unit 27. When lignin depolymerization unit 29 is present, the non-aqueous stream with depolymerized lignin can be provided via line 30 to non-aqueous stream distillation unit 27.

Liquid-liquid phase separation unit 20 allows the reaction product to coalesce into the respective phases, which can then be separated from one another. The reaction product generally has an aqueous phase and at least one non-aqueous phase. Under certain conditions, the aqueous phase and the non-aqueous phase(s) coalesce into two layers. Under other conditions, the aqueous phase and the non-aqueous phase(s) can coalesce into three layers. In particular, there can be an aromatics layer on top of an aqueous layer, which is on top of another non-aqueous layer. One illustrative condition includes a temperature of the reaction product above about 150 degrees C., the non-aqueous phase(s) may be on top of the aqueous layer. When the temperature of the reaction product is below about 150 degrees, at least one non-aqueous layer may become denser than the aqueous phase and sinks below. If mono-oxygenated aromatics or other non-water miscible compounds are present, the aromatics may tend to coalesce above the aqueous layer to form another non-aqueous layer, which can result in the mentioned three layers.

The reaction product entering liquid-liquid phase separation unit 20 is an emulsion where there is at least some mixing of the phases with one another. One illustrative way to allow the phases and/or layers to coalesce is to reduce the temperature of the reaction product. The temperature reduction can be at least 20 degrees C. For instance, a temperature of the reaction product in liquid-liquid phase separation unit 20 can be in a range of 20 to 150 degrees C., or any range therein, lower than a temperature of the reaction product exiting hydrothermal digestion unit 2 in FIG. 1 or phenolics conversion unit 16 in FIG. 2. Non-limiting illustrative temperature differences can be 20 degrees C., 30 degrees C., 40 degrees C., 50 degrees C., 60 degrees C., 70 degrees C., 80 degrees C., 90 degrees C., 100 degrees C., 110 degrees C., 120 degrees C., 130 degrees C., 140 degrees C., 150 degrees C., or any temperature in between. If gas separator unit 18 is present, the release of excess gas also provides thermal energy removal that can result in a drop in temperature of the reaction product entering liquid-liquid phase separation unit 20.

Additionally or alternatively, another way to allow the phases and/or layers to coalesce is to provide residence time in liquid-liquid phase separation unit 20 so gravity can act upon the difference in density between the phases and/or layers. The residence time in unit 20 can be at least 5 minutes. For instance, the reaction product can spend in a range of 5 to 30 minutes in liquid-liquid phase separation unit 20 or any range therein. Non-limiting illustrative residence times can be 5 minutes, 10 minutes, 15 minutes, 20 minutes, 25 minutes, 30 minutes or any time in between.

Additionally or alternatively, another way to allow the phases and/or layers to coalesce is to provide residence time in liquid-liquid phase separation unit 20 is to augment gravitational force with a centripetal force, such as through use of a centrifuge or hydroclone device.

In liquid-liquid phase separation, the settling into the different phases is optimal when the amount of each phase present in the emulsion is roughly equal to one another, for example, 1:1. As mentioned, the reaction product generated by either hydrothermal digester 2 in FIG. 1 or phenolics conversion unit 16 in FIG. 2 is a mixture of an aqueous phase and at least one non-aqueous phase, so it is typically an emulsion that tends to have a higher amount of water than other compounds. The breaking of the reaction product emulsion into layers and/or phases can be enhanced if the concentration of the non-aqueous phase(s) can be increased to bring it closer to a 1:1 ratio with the aqueous phase. FIG. 3 illustrates one option of how the concentration of the non-aqueous phase(s) can be increased. As shown, at least a portion of the non-aqueous stream coming out of liquid-liquid phase separation unit 20 can be provided, via line 31, to the reaction product entering liquid-liquid phase separation unit 20 via line 26. As shown, the material in line 31 may be combined with the reaction product prior to entering liquid-liquid phase separation unit 20. Additionally or alternatively, the non-aqueous stream in line 31 may be provided to liquid-liquid phase separation unit 20 to be mixed with the reaction product in unit 20.

Supplementing the reaction product with the non-aqueous stream increases the non-aqueous phase(s) concentration in liquid-liquid phase separation unit 20, which can enhance coalescing of the phases. This is still considered to be liquid-liquid phase separation where an extraction solvent is not added as compared to liquid-liquid extraction where an extraction solvent is added, whereby extraction solvent is a solvent mixture of different composition from the liquid phase being separated. The non-aqueous stream in line 31 is therefore not considered an extraction solvent because it has a similar composition as the non-aqueous phase(s) in the reaction product in line 26, and its composition has not been altered to become a solvent.

Referring to FIGS. 1-3, liquid-liquid phase separation unit 20 can be any suitable liquid-liquid phase separation that allows the aqueous phase to be separated from the non-aqueous phase(s). Non-limiting illustrative examples of liquid-liquid phase separation unit 20 include horizontal settling tanks, one or more weirs, centrifuge- or hydroclone-type device, and devices that facilitate coalescing, including a fiber coalesce or a packed bed coalescing mat. It is understood that liquid-liquid phase separation unit 20 can comprise more than device to provide the necessary and/or desired separation.

Liquid-liquid phase separation unit 20 can be operated in batch mode, semi-batch mode, continuous mode, or any combination thereof. In batch mode, an amount of the respective reaction product enters liquid-liquid phase separation unit 20 and is allowed to settle into the respective phases and/or layers. The aqueous phase can be identified and removed as an aqueous stream leaving the remaining content as the non-aqueous phase(s), which can be removed as a non-aqueous stream before a subsequent batch of reaction product is provided to liquid-liquid phase separation unit 20. Removal can be done using methods known to one of ordinary skill. An example is inserting a tube into a particular layer to withdraw that layer. Additionally or alternatively, the non-aqueous phase(s) can remain in unit 20 when a subsequent batch is added to provide enhanced phase separation as described above with respect to FIG. 3.

Liquid-liquid phase separation unit 20 can also be operated in semi-continuous or continuous mode where the respective reaction product flows through liquid-liquid phase separation unit 20. One non-limiting illustrative example is a horizontal settling tank where the length and/or flow rate of the reaction product can be adjusted to provide the necessary residence time so that the respective phases and/or layers have coalesced when the reaction product reaches an outlet of the settling tank where they are removed independent of one another. For enhanced phase separation as shown in FIG. 3 in semi-continuous or continuous mode, a portion of the non-aqueous stream in line 24 can be partitioned and recycled back to reaction product in line 26.

As mentioned, the aqueous stream comprises a major portion of the water present in the reaction product provided to liquid-liquid phase separation unit 20. For instance, the aqueous stream comprises greater than 50 wt %, including 55 wt % or greater, 60 wt % or greater, 70 wt % or greater, particularly 75 wt % or greater, 80 wt % or greater, 85 wt % or greater, 90 wt % or greater, and 95 wt % or greater of the water in the reaction product in unit 20. Correspondingly, the non-aqueous stream comprises a minor portion of the water in the reaction product provided to liquid-liquid phase separation unit 20. For instance, the non-aqueous stream comprises up to 50 wt %, including an amount in a range of 0.1 wt % and up to 50 wt %, up to 45 wt %, up to 40 wt %, up to 35 wt %, up to 30 wt %, up to 25 wt %, up to 20 wt %, up to 15 wt %, up to 10 wt %, or up to 5 wt % of water in the reaction product in unit 20. The non-aqueous stream comprises the remaining portion of the reaction product not in the aqueous stream. For instance, if the reaction product coalesces into three layers, and the aqueous phase is the middle layer, separation of the aqueous phase leaves the remaining two layers as the non-aqueous stream. Additionally or alternatively, the layers can be individually recovered and the non-aqueous layers can be combined as the non-aqueous stream. For instance, the non-aqueous stream may have more than one phase.

In addition to water, the aqueous stream further comprises compounds that are miscible with water. These include light compounds, middle-boiling compounds, heavy compounds, water-soluble salts, and ash. The light compounds include those that have a normal boiling point of less than 150 degrees C. Non-limiting illustrative examples of light compounds include monohydric alcohols, aldehydes, ketones, acids, and any combination thereof. The middle-boiling compounds present in the aqueous stream include those that have a normal boiling point in a range of 150 to 350 degrees C. or greater, which can include glycols and phenols. The heavy compounds include those that have a normal boiling point of greater than 350 degrees C.

Referring to FIGS. 1-3, the aqueous stream can be provided via line 28 to aqueous stream separation zone 25. In zone 25, light compounds can be recovered from the aqueous stream The aqueous stream can be subject to flashing with reduced steam stripping effect because the aqueous stream contains a reduced amount of phenols compared to the reaction product having multiple liquid phases, such that a separate phenolic-rich phase can be minimized during the flashing step Flashing of the aqueous stream recovers various light compounds that can be further processed into a fuel product. Light compounds can include those with a normal boiling point of less than 150 degrees C., including but not limited to monohydric alcohols, aldehydes, ketones, acids, and any combination thereof.

Referring to FIGS. 1-3, a major portion of light compounds in the aqueous stream is recovered in aqueous stream separation zone 25. For instance, more than 50 wt %, particularly at least 75 wt %, at least 80 wt %, at least 85 wt %, at least 90 wt %, or at least 95 wt % of compounds with a normal boiling point of less than 150 degrees C. in the aqueous stream in zone 25 is recovered. These light compounds can be provided via line 32 to further processing zone 22 where they can be further processed in a desired product, as further discussed below. The light compounds coming from aqueous stream separation zone 25 via line 32 may be combined with excess gas in line 23 from gas separator unit 18, if present, before entering further processing zone 22 as shown in FIGS. 1-2. Additionally or alternatively, it may enter zone 22 separately. In certain instances, heavier compounds, such as those with a normal boiling point of 150 degrees C. or greater, including phenols and glycols, may also be recovered in aqueous stream separation zone 25. If these heavier compounds are recovered in zone 25, they can be provided to digestion zone 3 and/or reaction zone 17 via line 33 as shown in FIGS. 1 and 2. In particular, FIG. 1 shows line 33 between hydrothermal digestion unit 2 and aqueous stream separation zone 25, and FIG. 2 shows line 33 between phenolics conversion unit 16 and zone 25. It is understood that line 33 can run to hydrothermal digestion unit 2 in FIG. 2 even though it is not shown. As mentioned, glycols and/or phenols can be used as part of the digestion solvent in zone 3. Additionally or alternatively, in phenolics conversion unit 16, the glycols can be further converted to monooxygenated intermediates, such as certain light compounds, including monohydric alcohols, and/or the phenols can be converted to hydrocarbons. Contaminants such as salts, ash, caramel, and tar remaining can be disposed of as waste and/or byproduct via line 34.

Aqueous stream separation zone 25 can comprise any suitable method known to one of ordinary skill in the art used to separate these light compounds. For instance, zone 25 can comprise one or more flashers. In one circumstance, which is not shown, zone 25 can comprise one flasher to flash the aqueous stream to recover light compounds in the overhead fraction while the bottom fraction containing water-soluble salts and ash can be discarded as waste. The bottom fraction from a single flash, however, can also contain other valuable heavier compounds, such as phenols and glycols. FIG. 4 shows one option of aqueous stream separation zone 25 to recover these valuable heavier compounds where zone 25 comprises more than one flasher: flasher 35 and flasher 36. In FIG. 4, light compounds are recovered in the overhead fraction of flasher 35, which is provided to further processing zone 22 via line 32. The bottom fraction of flasher 35 is provided to flasher 36 via line 37. In flasher 36, heavier valuable compounds, including phenols and glycols, are recovered in the overhead fraction, which can be provided to digestion zone 3 and/or reaction zone 17 via line 33. Contaminants exit as waste via line 34. Other suitable separation methods that may be employed in aqueous stream separation zone 25 includes use of membranes for separation of organics and salts from water. Optionally the bottom fraction from a single flash containing valuable heavier compounds, such as phenols and glycols, can be recycled back to hydrothermal digestion unit 2 and/or phenolics conversion unit 16 with a small amount of purge to maintain the levels of undesirable compounds to a certain level, such as those that can be detrimental to the reactions in hydrothermal digestion unit 2 and/or phenolics conversion unit 16.

Referring to FIGS. 1-3, as mentioned, the non-aqueous stream coming from liquid-liquid phase separation unit 20 can be provided to optional lignin depolymerization unit 29 before entering non-aqueous stream distillation unit 27. If present, the non-aqueous stream can enter unit 29 via line 24. Lignin depolymerization unit 29 can improve product separation of the non-aqueous stream by reducing its viscosity through one or more lignin depolymerization reactions. Lignin depolymerization unit 29 can comprise any suitable lignin depolymerization reaction.

Suitable lignin depolymerization reactions are known in the art. Non-limiting illustrative lignin depolymerization reactions include thermal reactions, which can be performed with or without catalysts. Generally, thermal lignin depolymerization reactions performed without catalysts typically take place in a temperature of greater than 300 degrees C. Catalysts and hydrogen can be added to reduce the reaction to below 300 degrees C. Any suitable catalyst can be employed, including acid or basic catalysts, in solid or liquid form. For example, methods relating to lignin depolymerization catalysts using a solid catalyst are described in U.S. Application Publication No. 2012/0302796, the disclosures of which are incorporated by reference in its entirety. Other disclosures relating to using catalysts in lignin depolymerization include U.S. Pat. Nos. 6,100,385 and 7,964,761, the disclosures of which are incorporated by reference in their entirety. Other methods to depolymerize lignin in the non-aqueous stream include pyrolysis (thermolysis), gasification, hydrogenolysis, chemical oxidation, and hydrolysis under supercritical conditions. Additional details regarding these methods can be found in Pandey & Kim, “Lignin Depolymerization and Conversion: A Review of Thermochemical Methods,” Chem. Eng. Technol., 2011, No. 1, 29-41, the disclosure of which is incorporated by reference in its entirety. If lignin is still present in the non-aqueous stream prior to full distillation, it may become precipitated and form a slurry of lignin. In this circumstance, optionally, a lignin removal mechanism may be used to capture at least a portion of this lignin in the non-aqueous stream prior to full distillation. Any suitable lignin removal mechanism may be used. Non-limiting suitable lignin removal mechanism includes a filter, a press, a hydroclone apparatus, or any combination thereof. The lignin captured by the lignin removal mechanism may be provided to lignin depolymerization unit 29 for further depolymerization or any other depolymerization step.

Referring to FIGS. 1-3, the non-aqueous stream with optionally depolymerized lignin exiting unit 29 is provided via line 30 to non-aqueous stream distillation unit 27, which can comprise any suitable distillation systems or methods, including multi-stage distillation. As shown, in non-aqueous stream distillation unit 27, the non-aqueous stream is distilled into various product fractions, including an overhead fraction, one or more middle fractions, and a bottom fraction.

An overhead fraction separated from the non-aqueous stream, which is depicted as line 38, includes a major portion of light compounds in the non-aqueous stream provided to distillation unit 27. For instance, more than 50 wt %, particularly at least 75 wt %, at least 80 wt %, at least 85 wt %, at least 90 wt %, or at least 95 wt % of compounds with a normal boiling point of less than 150 degrees C. present in the non-aqueous stream in distillation unit 27 is in the overhead fraction in line 38.

The middle fraction can comprise compounds heavier than the light compounds, particularly those with a normal boiling point of 150 degrees C. or greater. Distillation unit 27 can be operated to provide more than one middle fraction. For instance, distillation can be operated to provide a first middle fraction, depicted as line 39, with a normal boiling point of about 150 to 250 degrees C., which typically captures phenolic compounds, and a second middle fraction, depicted as line 40, with a higher normal boiling point of 200 to 350 degrees C., which typically captures lignin oligomers. Distillation can also be operated to provide a middle fraction with a normal boiling point of about 150 to 350 degrees C. As mentioned above, there is an overlap in the normal boiling point of the middle fractions, which is at least due to the distribution of compounds during the distillation process. Accordingly, the first middle fraction in line 39 can include compounds with a normal boiling point in a range of about 150 to 300 degrees C. The second middle fraction, which is depicted as line 40, can include compounds with a normal boiling point of 200 to 350 degrees C., which typically captures lignin oligomers. The bottom fraction depicted as line 41 has compounds with a normal boiling point of greater than 350 degrees C., which typically capture the heaviest of compounds regarded as waste or byproducts, such as caramel and/or tar. While the first middle fraction may be referred to as the phenols fraction and the second middle fraction may be referred to as the lignin oligomers fraction, it is understood that the phenols fraction may contain lignin oligomers, and the lignin oligomers may contain phenols. It is understood that a middle fraction distilled from the non-aqueous stream can be the phenols fraction, the lignin oligomers fraction, or a combination thereof. As described, separation zone 13 provides one or more middle fraction that contains a major portion of phenolics in the reaction product provided to separation zone 13.

Referring to FIGS. 1-2, the overhead fraction from the distillation unit 27 can be provided to further processing zone 22 via line 38. As shown, material in line 38 may be combined with other light compounds in line 32 recovered from the aqueous stream and/or excess gas in line 23 recovered from gas separator unit 18, if present, before entering further processing unit 22. Additionally or alternatively, material in line 38 may be provided to further processing zone 22 separately.

Referring to FIGS. 1-2, at least a portion of the one or more middle fractions from distillation unit 27 can be provided to digestion zone 2 and/or reaction zone 17. In FIGS. 1-2, the first middle fraction containing phenols in line 39 is provided to hydrothermal digestion unit 2 via line 44 for use as part of the digestion solvent. The amount of the phenols fraction provided may be determined by the amount of lignin provided to hydrothermal digestion unit 2. For instance, phenols can be provided at a ratio of at least 1 part phenols to 2 parts lignin (1:2), including a ratio in a range of 1 part phenols to 2 parts lignin (1:2) to 10 parts phenols to 1 part lignin (10:1), or any ratio in between. Non-limiting illustrative ratios include at least 1 part phenols to 1 part lignin (1:1), 2 parts phenols to 1 part lignin (2:1), 3 parts phenols to 1 part lignin (3:1), 4 parts phenols to 1 part lignin (4:1), 5 parts phenols to 1 part lignin (5:1), 6 parts phenols to 1 part lignin (6:1), 7 parts phenols to 1 part lignin (7:1), 8 parts phenols to 1 part lignin (8:1), 9 parts phenols to 1 part lignin (9:1), 10 parts phenols to 1 part lignin (10:1), and any combination thereof.

Additionally or alternatively, in FIG. 2, the phenols fraction is also provided to phenolics conversion unit 16 via line 42. The phenols can be further converted into hydrocarbons in unit 16 as described herein. Additionally or alternatively, while not preferred and not depicted in the figures, the second middle fraction containing lignin oligomers in line 40 can be provided to hydrothermal digestion unit 2. The lignin can be further reverted into phenols in unit 16 as described herein. As shown in FIG. 2, the phenols fraction in line 39 is optionally combined, via line 39A, with the lignin oligomers fraction in line 40, the mixture is then provided to phenolics conversion unit 16 via line 42. It is understood that the phenols fraction in line 39 may be provided to hydrothermal digestion unit 2 separately.

That is, under some circumstance, only the phenols fraction, and not the lignin oligomers fraction, is recycled back via line 39 and/or line 42 to digestion zone 3 and/or reaction zone 17, respectively, as described. In some other circumstances, only the lignin oligomers fraction, and not the phenols fraction, is recycled back via line 40 and/or line 42 to digestion zone 3 and/or reaction zone 17, respectively, as described. In yet other circumstances, at least some portion of the phenols fraction and the lignin oligomers fraction are recycled via line 39, line 40, and/or line 42 to digestion zone 3 and/or reaction zone 17, respectively, as described. In these circumstances, the phenols fraction and the lignin oligomers fraction may be combined then provided to digestion zone 3 and/or reaction zone 17. Additionally or alternatively, they may be provided separately. While not shown, a portion of material in line 39 and/or line 40 may be purged as needed.

Referring to FIG. 2, the amount of a middle fraction distilled from the non-aqueous stream provided to conversion unit 16 affects the amount of phenolics concentration in unit 16. As mentioned, it is preferred that the phenolics concentration, which includes the amount of lignin oligomers, in phenolics conversion unit 16 is maintained at 50 wt % or below. If the first reaction product from hydrothermal digestion unit 2 that goes to phenolics conversion unit 16 already contains a certain phenolics concentration, this is taken into account if a portion of a middle fraction distilled from the non-aqueous stream is added to unit 16 so that the phenolics concentration in unit 16 can be maintained as needed or desired. For instance, the fraction from at least one of line 39 and line 40 may be provided to phenolics conversion unit 16 at a ratio to or percentage the first reaction product in line 12. In particular, a non-limiting, illustrative example includes the amount of material from at least one of line 39 and line 40 is no more than 50 wt % of the amount or flow rate of the first reaction product in line 12. In this circumstance, the amount of the first reaction product is at least two parts to one part of material from at least one of line 39 and line 40.

As shown in FIGS. 1-3, material from at least one of line 39 and line 40 can also be provided to lignin depolymerization unit 29, if present, via line 43. At least the lignin in the material from at least one of line 39 and line 40 can be further depolymerized, which improves distillation efficiency in distillation unit 27, as the viscosity of the material provided via line 30 is further reduced.

Some or all of material in at least one of line 39 and line 40 may be provided to lignin depolymerization unit 29. For instance, at least 10 wt % of the material in a middle fraction distilled from the non-aqueous stream is provided to lignin depolymerization unit 29, particularly, at least 20 wt %, at least 30 wt %, at least 40 wt %, at least 50 wt %, at least 60 wt %, at least 70 wt %, at least 80 wt %, or at least 90 wt %. The amount may be selected by one of ordinary skill in the art by balancing different factors, including the use of phenols as solvent in hydrothermal digestion unit 2 and further lignin reversion and conversion to hydrocarbons in phenolics conversion unit 16. Recycling more material to one location leaves less material for recycling to other locations. An external solvent (i.e., one that is not recycled) may be provided to system 1, particularly in hydrothermal digestion unit 2, at start up or as needed during the process.

Referring to FIGS. 1-2, further processing zone 22 can comprise any suitable number of reactors coupled to one another, such as at least one, two, three, four, five, or six further processing units. The reaction(s) taking place in further processing zone 22 can convert the alcoholic component to the desired hydrocarbon compounds. While not shown, hydrocarbons converted from phenolics that are in the second reaction product may be separated from the second reaction product before it is routed to further processing zone 22, or the hydrocarbons may remain in the second reaction product and go through further processing zone 22 as described herein. In addition, hydrogen and water vapor may or may not be removed prior to the further processing of the remaining fraction.

Referring to FIGS. 1-3, further processing zone 22 may generally comprise a condensation reaction, often conducted in the presence of a condensation catalyst, in which the alcoholic component or a product formed therefrom is condensed with another molecule to form a higher molecular weight compound. As used herein, the term “condensation reaction” will refer to a chemical transformation in which two or more molecules are coupled with one another to form a carbon-carbon bond in a higher molecular weight compound, usually accompanied by the loss of a small molecule such as water or an alcohol. An illustrative condensation reaction is the Aldol condensation reaction, which will be familiar to one having ordinary skill in the art.

Although a number of different types of catalysts may be used for mediating condensation reactions, zeolite catalysts also may be particularly advantageous in this regard. One zeolite catalyst that may be particularly well suited for mediating condensation reactions of alcohols is ZSM-5 (Zeolite Socony Mobil 5), a pentasil aluminosilicate zeolite having a composition of NanAlnSi96-n0192.16H2O (0<n<27), which may transform an alcohol feed into a condensation product. Other suitable zeolite catalysts may include, for example, ZSM-12, ZSM-22, ZSM-23, SAPO-11, and SAPO-41.

In various embodiments, the condensation reaction may take place at a temperature ranging between about 275 degrees C. and about 450 degrees C. The condensation reaction may take place in a condensed phase (e.g., a liquor phase) or in a vapor phase. For condensation reactions taking place in a vapor phase, the temperature may range between about 300 degrees C. and about 400 degrees C., such as 350 degrees C. or above. The condensation reaction may take place at a pressure in a range of about 5 bar to 50 bar, such as 10 bar to 30 bar, including about 15 bar to 20 bar.

The alcoholic component, particularly when it includes methanol and an oxygenate, such as such as at least one of ketones, aldehydes, furans, and ethers, can provide for improved conversion of methanol over to a fuel compound, such as gasoline or diesel, as compared to other conventional methanol conversion processes. An example of such a conventional methanol conversion process is the methanol-to-gasoline process.

The higher molecular weight compound produced by the condensation reaction may comprise >C4 hydrocarbons, such as C4-C30 hydrocarbons, C4-C24 hydrocarbons, C4-C18 hydrocarbons, or C4-C12 hydrocarbons; or >C6 hydrocarbons, such as C6-C30 hydrocarbons, C6-C24 hydrocarbons, C6-C18 hydrocarbons, or C6-C12 hydrocarbons. As used herein, the term “hydrocarbons” refers to compounds containing both carbon and hydrogen without reference to other elements that may be present. Thus, heteroatom-substituted compounds are also described herein by the term “hydrocarbons.” The particular composition of the higher molecular weight compound produced by the condensation reaction may vary depending on the catalyst(s) and temperatures used for both the catalytic reduction reaction and the condensation reaction, as well as other parameters such as pressure.

A single catalyst may mediate the transformation of the alcoholic component into a form suitable for undergoing a condensation reaction as well as mediating the condensation reaction itself. Zeolite catalysts are one type of catalyst suitable for directly converting alcohols to condensation products in such a manner. A particularly suitable zeolite catalyst in this regard may be ZSM-5, although other zeolite catalysts may also be suitable.

On the other hand, a first catalyst may be used to mediate the transformation of the alcoholic component into a form suitable for undergoing a condensation reaction, and a second catalyst may be used to mediate the condensation reaction. Unless otherwise specified, it is to be understood that reference herein to a condensation reaction and condensation catalyst refers to either type of condensation process. Further disclosure of suitable condensation catalysts now follows. Zeolite catalysts may be used as either the first catalyst or the second catalyst. Again, a particularly suitable zeolite catalyst in this regard may be ZSM-5, although other zeolite catalysts may also be suitable.

Various catalytic processes may be used to form higher molecular weight compounds by a condensation reaction. In some embodiments, the catalyst used for mediating a condensation reaction may comprise a basic site, or both an acidic site and a basic site. Catalysts comprising both an acidic site and a basic site will be referred to herein as multi-functional catalysts. In some or other embodiments, a catalyst used for mediating a condensation reaction may comprise one or more metal atoms. Any of the condensation catalysts may also optionally be disposed on a solid support, if desired. Additional details regarding suitable catalysts are described in commonly owned United States Patent Application Publication US20140117277, filed Oct. 30, 2013, and entitled Methods and Systems for Processing Lignin During Hydrothermal Digestion of Cellulosic Biomass Solids,” the entire disclosure of which is incorporated herein by reference.

For example, the condensation catalyst may also include a zeolite and other microporous supports that contain Group IA compounds, such as Li, Na, K, Cs and Rb. Preferably, the Group IA material may be present in an amount less than that required to neutralize the acidic nature of the support. A metal function may also be provided by the addition of group VIIIB metals, or Cu, Ga, In, Zn or Sn. In some embodiments, the condensation catalyst may be derived from the combination of MgO and Al₂O₃ to form a hydrotalcite material. Another condensation catalyst may comprise a combination of MgO and ZrO₂, or a combination of ZnO and Al₂O₃. Each of these materials may also contain an additional metal function provided by copper or a Group VIIIB metal, such as Ni, Pd, Pt, or combinations of the foregoing.

The condensation reaction mediated by the condensation catalyst may be carried out in any reactor of suitable design, including continuous-flow, batch, semi-batch or multi-system reactors, without limitation as to design, size, geometry, flow rates, and the like. The reactor system may also use a fluidized catalytic bed system, a swing bed system, fixed bed system, a moving bed system, or a combination of the above. In some embodiments, bi-phasic (e.g., liquid-liquid) and tri-phasic (e.g., liquid-liquid-solid) reactors may be used to carry out the condensation reaction.

To facilitate a better understanding of the present invention, the following examples of preferred embodiments are given. In no way should the following examples be read to limit, or to define, the scope of the invention.

### EXAMPLES

### Example 1

### Phase Separation of Phenolic-Solvent from MIBC-Rich Organic-Water Solvent

A solvent mixture was prepared from 57.02 grams of methylisobutylcarbinol and 3.01 grams of deionized water. A 100-milliliter Parr 4590 series reactor was charged with the solvent mixture, together with 0.19 grams of potassium carbonate buffer, and 1.8 grams of nickel-oxide promoted cobalt molybdate catalyst (DC-2534, containing 1-10% cobalt oxide and molybdenum trioxide (up to 30 wt %) on alumina, and less than 2% nickel). The catalyst was obtained from Criterion Catalyst & Technologies L.P. and sulfided by a method described in Example 5 of U.S. Application Publication No. 2010/0236988. The reactor was then charged with 6 grams of southern pine mini-chips (50% moisture) with size of about 3×5×5 mm in dimension, before pressuring with 52 bar of hydrogen, and heating with stirring to 190° C. for 1 hour, followed by heating to 250° C. for 4 hours.

After 6 cycles of wood addition, a mixed sample was withdrawn via filtered sintered metal dip tube to reveal after cooling the presence of upper (65%) and middle phases (30%), with globules of a third phase present as droplets on the bottom of the sample. The reactor liquid phase samples were analyzed by gas chromatography using a 60-m×0.32 mm ID DB-5 column of 1 μm thickness, with 50:1 split ratio, 2 ml/min helium flow, and column oven at 40° C. for 8 minutes, followed by ramp to 285° C. at 10° C./min, and a hold time of 53.5 minutes. Acetone was used as diluent for GC analysis of the bottom droplet or globule phase. The injector temperature was set at 250° C., and the detector temperature was set at 300° C. Gas Chromatographic-Mass Spec (GCMS) was effected using the same protocol.

Result of GCMS revealed an upper layer comprising 64% by weight methylisobutylcarbinol (MIBC) and methylisobutyl ketone, 1.3 wt % methoxypropylphenol, and an array of light alcohols and diols of carbon number less than or equal to six. The middle layer comprised water, and yielded and organic fraction rich in ethylene glycol and propylene glycol, comprising together about 30 wt % of the organics detected by GC. The bottom globules were found to be rich in phenols with some diols, wherein methoxypropylphenol (MPP) was the largest single component present at 17.6 wt %.

This example shows that multiple phases can form from digestion and reaction of wood with hydrogen and catalyst in a mixed organic—aqueous solvent. Whereas separation of an aqueous layer was expected from progressive addition of wet wood to a solvent mixture of rich in methylisobutylcarbinol (partially water miscible), the formation of a third layer, which was another non-aqueous, organic-rich (phenolic) layer including methoxypropylphenol and other phenols formed from wood, upon sampling and cooling, was unexpected. An upper organic-rich layer was observed, together with an aqueous rich phase, and a phenolic rich layer which separated from the upper layer upon cooling, to form globules on the bottom of the sample jar. Phase separations observed upon complete or partial cooling after reaction, can be used to select compositions for recycle as solvent, or further processing to biofuels.

### Example 2

### Larger Scale Synthesis of Phenolic Rich Phase

Example 1 was repeated using a 450-ml Parr reactor with 212.2 grams of MIBC and 5.01 grams of deionized water as solvent, 0.8556 grams of potassium carbonate buffer, 8.104 grams of the sulfided cobalt molybdate catalyst. 27 grams of southern pine wood at nominal 50% moisture were added for reaction cycles again conducted under 52 bar of H₂, with heating to 190 C for 1 hour, followed by 240 C for 4 hours.

The process was continued for 17 cycles of wood addition. For cycles 1-7, a mixed hot sample was removed via filtered dip tube at the end of reaction, to accommodate the mass of wood to be added in the next cycle, thus maintaining constant mass inventory in the reactor. The sintered metal dip tube plugged after seven cycles, such that product sample removal for cycle 8-18 was effected upon depressurizing and opening the reactor to remove primarily from the aqueous middle layer the amount of liquid corresponding to wood addition for the next cycle. After cycle 17, final reactor contents approached a pseudo steady state composition, and were poured into a glass jar to reveal approximately 28% of an MIBC-rich upper layer, 64% of a middle aqueous layer comprising water but rich in glycols ethylene glycol and propylene glycol, and 9% of a phase which separated from the upper layer, and formed globules on the bottom of the jar after further cooling. Methoxypropylphenol was again the dominant component in the lower globule phase.

This example again demonstrates the formation of phenolic solvent from digestion and hydrocatalytic conversion of wood, the separation of organic-rich and aqueous-rich layers upon initial cooling, and the further separation of a phenolic-rich phase.

### Example 3

### Distillation of Separated Phases

Approximately 25-gram aliquots of the final upper layer MIBC-rich and middle layer aqueous phases from Example 2, cycle 17 were separately distilled in a 100-ml distillation flask fitted with 4-stage Vigreux column. Distillation of the aqueous fraction yielded overhead cuts of light monooxygenates (alcohols less than C4), water, and upon increase in bottoms temperature, ethylene glycol and propylene glycol. No detectable phenolics were observed in the overhead cuts from the aqueous phase distillation.

The upper layer distillation yielded some light monooxygenate alcohols less than C4 early in the distillation, followed by C5 and C6 ketones and alcohols and including cyclopentanol, cyclopentanone, methyl cyclopentanone, hexanone.

Upon application of vacuum (100 torr absolute) and increasing the bottoms temperature to above 250 C but less than 310 C, an overhead distillation cut rich in phenolics was obtained, where in quantified phenolic total more than 70% of the sample.

TABLE 1
Composition of vacuum distillation cut at 250-
360 C. bottoms temperature from distillation of
upper layer from Example 2, cycle 17.

| Name | area % |
|---|---|
| acetone (diluent) | N/A |
| 1-butanol (int standard) | N/A |
| 4-methyl-2-Pentanol | N/A |
| tetrahydro | 3.27% |
| Furanmethanol | |
| phenol | 6.93% |
| methoxy phenol | 8.61% |
| methyl phenol | 12.39% |
| unknown | 3.89% |
| dimethy phenol | 7.37% |
| methyl methoxy phenol | 6.27% |
| ethyl phenol | 6.15% |
| methyl ethyl phenol | 5.51% |
| unknown | 2.58% |
| ethyl methoxy phenol | 5.24% |
| unknown | 3.76% |
| propyl phenol | 6.09% |
| unknown | 0.91% |
| benzene diol | 5.24% |
| propyl methoxy phenol | 6.30% |

This example shows an ability to phase separate a biomass digestion and reaction process using organic-rich solvent, and separately distill the upper organic rich phase to separate phenolic-rich components which can be recycled as solvent, as a distillate concentrate. Carbohydrates and intermediates such as ethylene glycol, ethylene glycol, are obtained via separate distillation of the aqueous rich layer. Light monooxygenates such as ethanol and propanol are obtained as early cuts from the atmospheric distillation of both upper organic and aqueous rich phases. Additional phenols are observed in a third bottoms layer from the reaction mixture, and can also be recovered by distillation.

### Example 4

### Multiple Phase Formation with Water Only as Solvent

The 100-mo Parr reactor was charged with 60.16 grams of deionized water, 0.754 grams of the DC2534 sulfided cobalt molybdate catalyst, and 0.195 grams of potassium carbonate buffer. 5.0-5.1 grams of nominal 50% wet pine wood chips were added for each digestion cycle, along with 52 bar of H₂ before heating to 190° C. for one hour, followed by 250° C. for 4 hours.

5-gram samples were removed each cycle via pressurization through dip tube fitted with 0.5 micron sintered metal filter to retain catalyst. By the second cycle, three phases were apparent upon initial cooling of the withdrawn samples: an upper non-aqueous layer, an aqueous layer in the middle, and globules of a lower non-aqueous layer. The extent of these phases grew with subsequent cycles of wood addition and reaction.

The upper non-aqueous layer contained primarily C5-C6 ketones and alcohols, including cyclic compounds. Glycols ethylene and propylene glycol were the dominant components of the aqueous layer. The globules of the non-aqueous phase where separated upon cooling from the upper layer, and fell to the bottom were rich in phenolic compounds as reported in Table 1.

This example shows that a layer of non-water miscible compounds (including oil) and a heavier non-aqueous layer of phenolics are formed from woody biomass during reaction with water as solvent. Upon partial cooling, the phases separate and may be separately processed by distillation or other means, for recovery of biofuels intermediates or recycle as solvent.

### Example 5

### Multiple Phase Formation with Mixed Alcohol-Water Solvent

Example 4 was repeated using 65.0 grams of a mixture of 50% ethanol and water as solvent, and 0.754 grams of DC2534 sulfided cobalt molybdate catalyst. The reaction sequence was continued through 7 cycles. A separate upper non-aqueous layer above the aqueous phase was not apparent, but the heavy globules of phenolic-rich lower non-aqueous layer were observed upon cooling of samples taken after cycle #3. This example shows the ability to separate a phenolic rich layer after reaction with an alcohol-water mixture as solvent.

### Example 6

### Use of Phenolic Solvent with Phase Separation

A 75-ml Parr5000 reactor was charged with 3.05 grams of m-cresol and 21.12 grams of deionized water, along with 0.305 grams of Raney Cobalt 2724 catalyst (WR Grace), and 0.08 grams of potassium hydroxide buffer. 2.04 grams of ground pine wood (nominal 10% moisture) were charged. The reactor was pressured to 52 bar with hydrogen, and heated to 190° C. for 1 hour, followed by heating to 240° C. for 4 hours.

At the end of 4 cycles of wood addition, two phases separated upon cooling and opting the reactor. The lower phenolic rich phase comprised 15% by volume of total liquids. A sample as diluted in 1:1 acetone for analysis by GC. Results indicated 19.5% cresol and 12.8 wt % other phenolic components formed from wood, in the lower non-aqueous bottoms phase.

The main aqueous rich layer contain 0.95 wt % ethylene glycol and 1.23 wt % 1,2-propylene glycol as the most prevalent of a myriad of reaction products derived from carbohydrate components in the wood feed.

This examples shows use of a phenolic phase as solvent for digestion of biomass, with separation upon cooling and concentration of the phenolics fed to the reactor, and additional phenolic solvent made from wood, into a bottoms phase which can be recycled for further digestion and reaction processing (either directly, or with further separation by distillation).

### Example 7

### Solubility of Alkylphenol in Water at Digestion Conditions

30 grams of 2,6-dimethylphenol (xylenol) and 30 grams of deionized water were charged to a 100-ml Parr reactor, pressured with 15 bar of N2, and heated to 240 C with stirring for one hour to equilibrate phases. Stirring was stopped, and phases were allowed to separate while hot, before sampling of all reactor contents via consecutive withdrawal of samples via a bottom dip tube. The weight fraction of xylenol in water for each aliquot withdrawn was determined by evaporation of water in a vacuum oven.

The weight fraction of xylenol in the first sample withdrawn from the bottom of the unstirred reactors was 18.6 weight percent. Further samples showed 26 and 32 weight percent xylenol with no slope above experimental error, as liquid above the near-bottom dip tube was sequentially withdrawn from the reactor. Averaging of these results yielded an estimate of 27.8 wt % xylenol in water for all samples taken after the first sample, with approximate constant composition.

This compares with a value of 29.7 wt % solubility of 2,6-xylenol in water reported by Erichsen, L and E. Dobbert Das gegenseitige loslichkeitsverhalten von alkylohenolen and wasser Brennstoff-Chemie vol. 36, pp 338-345.

Surprisingly, the xylenol was initially found to float on water upon initial sampling, but subsequently sank to form a bottom layer upon cooling. This result indicates that alkyl phenols can be less dense than water at digestion temperatures above 200° C., but cool to a density greater than water below 100° C., upon which the phase sinks to the bottom of an aqueous phase. This phenomenon explains the nucleation and formation of phenolic rich globules in the upper layer of samples withdrawn from multicycle digestion reactions with wood feed, which ultimately sink to the bottom after cooling.

For process design, one can separate a phenolic-rich phase with other organics as an upper layer for temperatures above about 200° C. Upon cooling to below 100° C., the phenolics phase separates as a bottoms layer separate from both aqueous and organic layers. Process optimization can therefore choose the temperature of separation, depending on whether more convenient to remove the phenolics phase as an upper phase with other organics, or as a separate lower phase.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods may also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

1. A method comprising:
heating cellulosic biomass solids, molecular hydrogen, a catalyst capable of activating molecular hydrogen, and a digestion solvent in a reactor in a first reaction zone to produce a first reaction product;
providing at least a portion of the first reaction product to a separation zone comprising a liquid-liquid phase separation unit to recover an aqueous stream and a non-aqueous stream, wherein the aqueous stream comprises a major portion of water in said portion of the first reaction product; and
providing at least a portion of the non-aqueous stream to a distillation unit to recover at least an overhead fraction, a middle fraction, and a bottom fraction,
providing at least a portion of the middle fraction to the reactor in the first reaction zone.

2. The method of claim 1 further comprising:
providing the aqueous stream to an aqueous stream separation zone to recover a light compounds from at least a portion of the aqueous phase in an overhead fraction, wherein the overhead fraction comprises a major portion of compounds with a normal boiling point of less than 150 degrees C. in said portion of the aqueous stream.

3. The method of claim 2 wherein the aqueous stream separation zone comprises at least one flasher to recover the overhead fraction.

4. The method of claim 2 wherein the aqueous stream separation zone comprises a first flasher and a second flasher, wherein the method further comprises:
providing the aqueous stream to the first flasher to recover a first overhead fraction and a first bottom fraction;
providing the first bottom fraction to the second flasher to recover middle-boiling compounds in a second overhead fraction and a second bottom fraction,
wherein the first overhead fraction comprises a major portion of compounds with a normal boiling point of less than 150 degrees C. in said portion of the aqueous stream, and
wherein the second overhead fraction comprises compounds with a normal boiling point of 150 degrees C. or higher.

5. The method of claim 4 further comprising:
providing at least a portion of the middle-boiling compounds in the second overhead fraction to the reactor in the first reaction zone.

6. The method of claim 1 further comprising:
at least partially depolymerizing lignin in the non-aqueous stream by providing at least a portion of the non-aqueous stream to a lignin depolymerization unit before providing it to the distillation unit.

7. The method of claim 6 further comprising:
providing at least a portion of the middle fraction from the distillation unit to the lignin depolymerization unit.

8. The method of claim 1 further comprising:
enhancing phase separation in the liquid-liquid phase separation unit by recycling at least a portion of the non-aqueous stream that exits the liquid-liquid phase separation unit with the first reaction product entering to the liquid-liquid phase separation unit.

9. The method of claim 4 further comprising:
providing the first reaction product to a gas separator unit to recover a vapor fraction comprising compounds with a normal boiling point of 100 degrees C. or lower.

10. The method of claim 9 further comprising:
providing to a further processing zone at least a portion of at least one of (i) the overhead fraction from the distillation unit; (ii) a first overhead fraction from the aqueous stream separation zone; and (iii) the vapor fraction from the gas separator unit, to generate a fuels product.

11. The method of claim 6 further comprising:
removing at least a portion of lignin in the non-aqueous stream prior to providing it to the distillation unit; and
providing at least a portion of the removed lignin to the lignin depolymerization unit.

12. A method comprising:
heating cellulosic biomass solids, molecular hydrogen, a catalyst capable of activating molecular hydrogen, and a digestion solvent in a reactor in a first reaction zone to produce a first reaction product;
heating at least a portion of the first reaction product, molecular hydrogen, and a catalyst capable of activating molecular hydrogen in a reactor in a second reaction zone to produce a second reaction product;
providing at least a portion of the second reaction product to a separation zone comprising a liquid-liquid phase separation unit to recover an aqueous stream and a non-aqueous stream, wherein the aqueous stream comprises a major portion of water in said portion of the second reaction product;
providing at least a portion of the non-aqueous stream to a distillation unit to recover at least an overhead fraction, a middle fraction, and a bottom fraction; and
providing at least a portion of the middle fraction to at least one of the reactor in the first reaction zone and the reactor in the second reaction zone.

13. The method of claim 12 further comprising:
providing the aqueous stream to an aqueous stream separation zone to recover a light compounds from at least a portion of the aqueous phase in an overhead fraction, wherein the overhead fraction comprises a major portion of compounds with a normal boiling point of less than 150 degrees C. in said portion of the aqueous stream.

14. The method of claim 13 wherein the aqueous stream separation zone comprises a first flasher and a second flasher, wherein the method further comprises:
providing the aqueous stream to the first flasher to recover a first overhead fraction and a first bottom fraction;
providing the first bottom fraction to the second flasher to recover middle-boiling compounds in a second overhead fraction and a second bottom fraction,
wherein the first overhead fraction comprises a major portion of compounds with a normal boiling point of less than 150 degrees C. in said portion of the aqueous stream, and
wherein the second overhead fraction comprises compounds with a normal boiling point of 150 degrees C. or higher.

13. The method of claim 14 further comprising:
providing at least a portion of the middle-boiling compounds in the second overhead fraction to at least one of the reactor in the first reaction zone and the reactor in the second reaction zone.

14. The method of claim 12 further comprising:
enhancing phase separation in the liquid-liquid phase separation unit by recycling at least a portion of the non-aqueous stream that exits the liquid-liquid phase separation unit with the first reaction product and/or the second reaction product entering to the liquid-liquid phase separation unit.

15. The method of claim 12 further comprising:
providing at least one of the first reaction product and the second reaction product to a gas separator unit to recover a vapor fraction comprising compounds with a normal boiling point of 100 degrees C. or lower.

16. A system comprising:
a first reaction zone comprising a reactor configured heat cellulosic biomass solids, molecular hydrogen, a catalyst capable of activating molecular hydrogen, and a digestion solvent to form a first reaction product; and
a separation zone comprising:
a liquid-liquid phase separation unit having an inlet in fluid communication with an outlet of the reactor in the first reaction zone to receive the first reaction product, wherein the liquid-liquid phase separation unit is configured to provide an aqueous stream and a non-aqueous stream, wherein the aqueous phase comprises a major portion of water in said portion of the first reaction product; and
a distillation unit having an inlet in fluid communication with an outlet of the liquid-liquid phase separation unit to receive at least a portion of the non-aqueous stream, wherein the distillation unit is configured to provide at least an overhead fraction, a middle fraction, and a bottom fraction;
wherein the distillation unit is in fluid communication with an inlet of the reactor in the first reaction zone to provide at least a portion of the middle fraction.

17. The system of claim 16 further comprising:
a lignin depolymerization unit in fluid communication with an outlet of the liquid-liquid phase separation unit to receive at least a portion of the non-aqueous stream, wherein the thermal reaction zone is configured to provide at least partial depolymerization of lignin in the non-aqueous stream,
wherein an outlet of the lignin depolymerization unit is in fluid communication with the distillation unit to provide the non-aqueous stream with at least partial lignin depolymerization.

18. The system of claim 16 wherein the separation zone further comprises:
an aqueous stream separation zone in fluid communication with an outlet of the liquid-liquid phase separation unit to receive at least a portion of the aqueous stream, wherein the aqueous stream separation zone is configured to provide an overhead fraction and a bottom fraction, wherein the overhead fraction comprises a major portion of compounds with a normal boiling point of less than 150 degrees C. in said portion of the aqueous stream.

19. The system of claim 18, wherein the aqueous stream separation zone comprises:
a first flasher configured to produce a first overhead fraction and a first bottom fraction, wherein the first overhead fraction comprises a major portion of compounds with a normal boiling point of less than 150 degrees C. in said portion of the aqueous stream, and
wherein the second overhead fraction comprises compounds with a normal boiling point of 150 degrees C. or higher;
wherein the first flasher comprises an outlet in fluid communication with an inlet of a second flasher to provide the first bottom fraction to the second flasher

20. The system of claim 16 further comprising a gas separator unit having an inlet in fluid communication with the first reaction zone, wherein the gas separator unit is configured to remove at least a portion of volatile compounds with a normal boiling point of 100 degrees C. or less than in the first reaction product, wherein an outlet of the gas separator unit is in fluid communication with the liquid-liquid phase separation unit to provide the reaction product without the removed volatile compounds to the liquid-liquid phase separation unit.

21. The system of claim 20 further comprising:
a further processing zone in fluid communication with at least one of (i) the separation zone to receive at least a portion of the overhead fraction from the distillation unit, (ii) the aqueous stream separation zone to receive at least a portion of the first overhead fraction from the aqueous stream separation zone, and (iii) the gas separator unit to receive at least a portion of the removed volatile compounds, wherein the further processing zone is configured to provide a fuels product.

22. The system of claim 17 further comprising:
a lignin removal mechanism having an inlet in fluid communication with an outlet of the lignin depolymerization unit to receive the non-aqueous stream with at least partial lignin depolymerization; wherein the lignin removal mechanism is configured to remove at least a portion of the lignin in the non-aqueous stream;
wherein the lignin removal mechanism has an outlet in fluid communication with the distillation unit to provide the non-aqueous stream from the lignin removal mechanism; and
wherein the lignin removal mechanism has an outlet in fluid communication with an inlet of the lignin removal mechanism to recycle the non-aqueous stream.

23. A system comprising:
a first reaction zone comprising a reactor configured heat cellulosic biomass solids, molecular hydrogen, a catalyst capable of activating molecular hydrogen, and a digestion solvent to form a first reaction product;
a second reaction zone comprising a reactor in fluid communication with an outlet of the reactor in the first reaction zone to receive the first reaction product, wherein the reactor in the second reaction zone is configured to heat a second reaction content comprising the first reaction product, molecular hydrogen, and a catalyst capable of activating molecular hydrogen to form a second reaction product; and
a separation zone comprising: and
a liquid-liquid phase separation unit having an inlet in fluid communication with an outlet of the reactor in the second reaction zone to receive the second reaction product, wherein the liquid-liquid phase separation unit is configured to provide an aqueous stream and a non-aqueous stream, wherein the aqueous stream comprises a major portion of water in said portion of the first reaction product; and
a distillation unit having an inlet in fluid communication with an outlet of the liquid-liquid phase separation unit to receive at least a portion of the non-aqueous stream, wherein the distillation unit is configured to provide at least an overhead fraction, a middle fraction, and a bottom fraction;
wherein the distillation unit is in fluid communication with an inlet of the reactor in the first reaction zone to provide at least a portion of the middle fraction; and
wherein the distillation unit is in fluid communication with an inlet of the reactor in the second reaction zone to provide at least a portion of the middle fraction.

24. The system of claim 23 further comprising:
a lignin depolymerization unit in fluid communication with an outlet of the liquid-liquid phase separation unit to receive at least a portion of the non-aqueous stream, wherein the thermal reaction zone is configured to provide at least partial depolymerization of lignin in the non-aqueous stream,
wherein an outlet of the lignin depolymerization unit is in fluid communication with the distillation unit to provide the non-aqueous stream with at least partial lignin depolymerization.

25. The system of claim 23 wherein the separation zone further comprises:
an aqueous stream separation zone in fluid communication with an outlet of the liquid-liquid phase separation unit to receive at least a portion of the aqueous stream, wherein the aqueous stream separation zone is configured to provide an overhead fraction and a bottom fraction, wherein the overhead fraction comprises a major portion of compounds with a normal boiling point of less than 150 degrees C. in said portion of the aqueous stream.

26. The system of claim 25, wherein the aqueous stream separation zone comprises:
a first flasher configured to produce a first overhead fraction and a first bottom fraction, wherein the first overhead fraction comprises a major portion of compounds with a normal boiling point of less than 150 degrees C. in said portion of the aqueous stream, and
wherein the second overhead fraction comprises compounds with a normal boiling point of 150 degrees C. or higher;
wherein the first flasher comprises an outlet in fluid communication with an inlet of a second flasher to provide the first bottom fraction to the second flasher.
